(19) United States
(12) Patent Application Publication
(10) Pub. No.: US 2023/0229372 A1
(43) Pub. Date: Jul. 20, 2023

(54) DISPLAY DEVICE, DISPLAY METHOD, AND COMPUTER-READABLE STORAGE MEDIUM

(71) Applicant: JVCKENWOOD Corporation, Yokohama-shi (JP)

(72) Inventors: Tetsuya Suwa, Yokohama-shi (JP); Hideo Tsuru, Yokohama-shi (JP); Motomu Takada, Yokohama-shi (JP); Takayuki Sugahara, Yokohama-shi (JP)

(21) Appl. No.: 18/102,112

(22) Filed: Jan. 27, 2023

Related U.S. Application Data
(63) Continuation of application No. PCT/JP2021/028675, filed on Aug. 2, 2021.

(30) Foreign Application Priority Data
Jul. 31, 2020 (JP) 2020-130656
Jul. 31, 2020 (JP) 2020-130877
Jul. 31, 2020 (JP) 2020-130878
Jul. 31, 2020 (JP) 2020-130879
Jul. 31, 2020 (JP) 2020-131024
Jul. 31, 2020 (JP) 2020-131025
Jul. 31, 2020 (JP) 2020-131026
Jul. 31, 2020 (JP) 2020-131027

(51) Int. Cl. G06F 3/14; G06F 3/01; G06V 20/20; G06Q 30/0273

(52) U.S. Cl. CPC G06F 3/14; G06F 3/015; G06V 20/20; G06Q 30/0273; G06V 2201/07

(57) ABSTRACT

A display device includes: a biological sensor configured to detect biological information of a user; an output-specification determining unit configured to determine a display specification of a sub-image to be displayed on a display unit based on the biological information of the user; an output control unit configured to cause the display unit to display the sub-image in a superimposed manner on a main image that is visually recognized through the display unit and based on the display specification; and an environment sensor configured to detect environment information of a periphery of the display device. The environment information includes location information of the user, and the biological information includes brain wave information of the user. The output-specification determining unit is configured to determine display time of the sub-image per unit time as the display specification based on the location information and the brain wave information.

### CROSS-REFERENCE TO RELATED APPLICATIONS

This application is a Continuation of PCT International Application No. PCT/JP2021/028675, filed on Aug. 2, 2021, which claims the benefit of priority from Japanese Patent Applications No. 2020-130656, No. 2020-131024, No. 2020-131025, No. 2020-131026, No. 2020-130877, No. 2020-130878, No. 2020-130879 and No. 2020-131027, filed on Jul. 31, 2020, the entire contents of all of which are incorporated herein by reference.

### BACKGROUND

The present disclosure relates to a display device, a display method, and a computer-readable storage medium.

Recently, with the advance of high-speed CPU, a technique of high definition screen display, and a technique of small and light battery, spread of wireless network environment and widened bandwidth, and the like, information devices have evolved significantly. As display devices that provide images to a user, not only smartphones, which is the representative example thereof, but also so called wearable devices that are worn by the user and the like have also been popularized. For example, in Japanese Patent Application Laid-open No. 2011-096171, a device that provides a sense as if a virtual object is actually present by presenting multiple kinds of sensing information to a user is described. Moreover, Japanese Patent Application Laid-open No. 2014-052518 describes that preferences of a user are determined from biological information, and advertising information is determined based on the determination result.

For display devices that provide an image to a user, appropriate provision of an image is desired.

### SUMMARY

A display device according to an embodiment includes: a display unit configured to display an image; a biological sensor configured to detect biological information of a user; an output-specification determining unit configured to determine a display specification of a sub-image to be displayed on the display unit based on the biological information of the user; an output control unit configured to cause the display unit to display the sub-image in a superimposed manner on a main image that is visually recognized through the display unit and based on the display specification; and an environment sensor configured to detect environment information of a periphery of the display device. The environment information includes location information of the user. The biological information includes brain wave information of the user. The output-specification determining unit is configured to determine display time of the sub-image per unit time as the display specification of the sub-image based on the location information of the user and the brain wave information of the user.

A display method according to an embodiment includes: detecting biological information of a user; determining a display specification of a sub-image to be displayed on a display unit based on the biological information of the user; detecting environment information of a periphery of the display unit; and causing the display unit to display the sub-image in a superimposed manner on a main image that is visually recognized through the display unit and based on the display specification. The environment information includes location information of the user. The biological information includes brain wave information of the user. The determining of the display specification includes determining display time of the sub-image per unit time as the display specification of the sub-image based on the location information of the user and the brain wave information of the user.

A non-transitory computer-readable storage medium according to an embodiment stores a computer program causing a computer to execute: detecting biological information of a user; determining a display specification of a sub-image to be displayed on a display unit based on the biological information of the user; detecting environment information of a periphery of the display unit; and causing the display unit to display the sub-image in a superimposed manner on a main image that is visually recognized through the display unit and based on the display specification. The environment information includes location information of the user. The biological information includes brain wave information of the user. The determining of the display specification includes determining display time of the sub-image per unit time as the display specification of the sub-image based on the location information of the user and the brain wave information of the user.

### BRIEF DESCRIPTION OF THE DRAWINGS

FIG. 1 is a schematic diagram of a display device according to a first embodiment;

FIG. 2 is a diagram illustrating an example of an image displayed by the display device;

FIG. 3 is a schematic block diagram of the display device according to the present embodiment;

FIG. 4 is a flowchart explaining processing of the display device according to the first embodiment;

FIG. 5 is a table explaining an example of an environment score;

FIG. 6 is a table showing an example of an environment pattern;

FIG. 7 is a diagram illustrating an example when a display mode is changed;

FIG. 8 is a diagram illustrating an example when the display mode is changed;

FIG. 9 is a diagram illustrating an example when the display mode is changed;

FIG. 10 is a table showing a relationship among an environment pattern, a target device, and a standard output specification;

FIG. 11 is a graph showing an example of a pulse wave;

FIG. 12 is a table showing an example of a relationship between a user state and an output-specification correction level;

FIG. 13 is a table showing an example of output-restriction necessity information;

FIG. 14 is a flowchart explaining processing of a display device according to a second embodiment;

FIG. 15 is a schematic block diagram illustrating a display device according to a third embodiment;

FIG. 16 is a flowchart explaining the processing of the display device according to the third embodiment;

FIG. 17 is a diagram illustrating an example of a display image according to the third embodiment;

FIG. 18 is a diagram illustrating an example of a sub-image in which a shape of a target object is shown in a shape different from an actual shape;

FIG. 19 is a schematic block diagram illustrating a display device according to a fourth embodiment;

FIG. 20 is a flowchart explaining the processing of the display device according to the fourth embodiment;

FIG. 21 is a schematic block diagram illustrating a display system according to the fourth embodiment;

FIG. 22 is a schematic block diagram illustrating a display device according to a fifth embodiment;

FIG. 23 is a flowchart explaining the processing of the display device according to the fifth embodiment;

FIG. 24 is a table explaining an example of age-restriction necessity information;

FIG. 25 is a table explaining an example of physical-restriction necessity information;

FIG. 26 is a table showing an example of content rating;

FIG. 27 is a schematic block diagram of a display device according to a sixth embodiment;

FIG. 28 is a flowchart explaining processing of the display device according to the sixth embodiment;

FIG. 29 is a table showing an example of final rating; and

FIG. 30 is a table explaining an example of determination of an output content based on the final rating.

### DETAILED DESCRIPTION

Hereinafter, the present embodiment will be explained in detail based on the drawings. The embodiment explained below is not intended to limit the present embodiment.

### First Embodiment

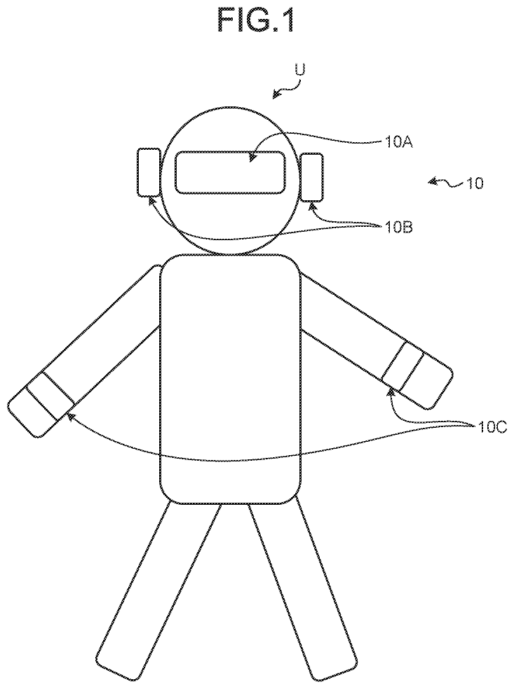

FIG. 1 is a schematic diagram of a display device according to a first embodiment. A display device 10 according to the first embodiment is a display device that displays an image. As illustrated in FIG. 1, the display device 10 is a so-called wearable device that is put on a body of a user U. In an example of the present embodiment, the display device 10 includes a device 10A that is put on eyes of the user U, a device 10B that is put on ears of the user U, and a device 10C that is put on arms of the user U. The device 10A put on the eyes of the user U includes a display unit 26A described later that outputs a visual stimulus (displays an image) to the user U, the device 10B that is put on the ears of the user U includes a sound output unit 26B described later that outputs an audio stimulus (sound) to the user U, and the device 10C that is put on the arms of the user U includes a tactile-stimulus output unit 26C described later that outputs a tactile stimulus to the user U. The configuration of FIG. 1 is one example, and the number of devices and the mounting positions on the user U may be arbitrarily determined. For example, the display device 10 is not limited to wearable device, but may be a device that is carried by the user U, and may be, for example, a so-called smartphone and tablet terminal, or the like.

Main Image

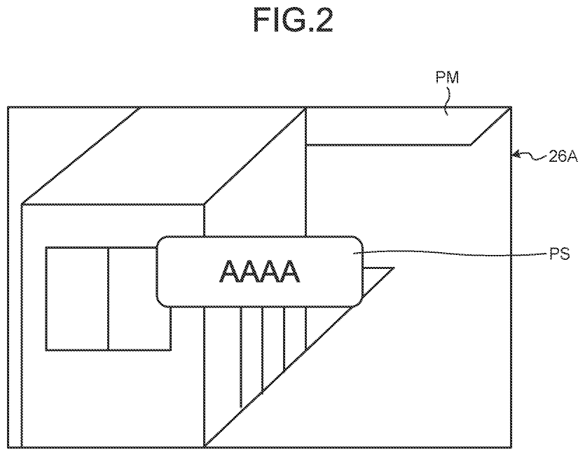

FIG. 2 is a diagram illustrating an example of an image displayed by the display device. As illustrated in FIG. 2, the display device 10 provides a main image PM to the user U through the display unit 26A. Thus, the user U wearing the display device 10 can visually recognize the main image PM. The main image PM is an image of scenery that is to be visually recognized by the user when it is assumed that the user U is not wearing the display device 10, and can be regarded as an image of a target object that is actually present within a field of view of the user U. In the present embodiment, the display device 10 provides the main image PM to the user U, for example, by letting outside light (ambient visible light) pass through the display unit 26A. That is, in the present embodiment, it can also be regarded that the user U directly visually recognizes an image of an actual scenery through the display device 26A. However, not limited to having the user U directly visually recognize an image of an actual scenery, the main image PM may be provided to the user U through the display unit 26A by displaying the image of the main image PM on the display unit A. In this case, the user U is to visually recognize the image of the scenery displayed on the display unit 26A as the main image PM. In this case, the display device 10 displays an image present in a range of a field of view of the user U captured by a camera 20A described later on the display unit 26A as the main unit PM. Note that streets and a building included in the main image PM in FIG. 2 are just one example.

Sub-Image

As illustrated in FIG. 2, the display device 10 causes the display unit 26A to display a sub-image PS superimposing on the main image PM provided through the display unit 26A. Thus, the user U is to visually recognize an image in which the sub-image PS is superimposed on the main image PM. The sub-image PS is an image that is superimposed on the main image PM, and can be regarded as an image other than a scenery that is actually present in a field of view of the user U. That is, it is regarded that the display device 10 provides augmented reality (AR) to the user by superimposing the sub-image PS on the main image PM, which is an actually existing scenery.

The sub-image PS may have arbitrary contents, but in the present embodiment, it is an advertisement. The advertisement herein signifies information informing a commodity product or a service. The sub-image is not limited to be an advertisement, and may be an image including information to be notified to the user U. For example, the sub-image may be a navigation image showing a direction to the user U. In FIG. 2, characters AAAA are the sub-image PS, but they are just one example.

As described, the display device 10 provides the main image PM and the sub-image PS, but may also display a content image having different contents from the main image PM and the sub-image PS on the display unit 26A. The content image may be images of any content, such as a movie and a TV program.

Configuration of Display Device

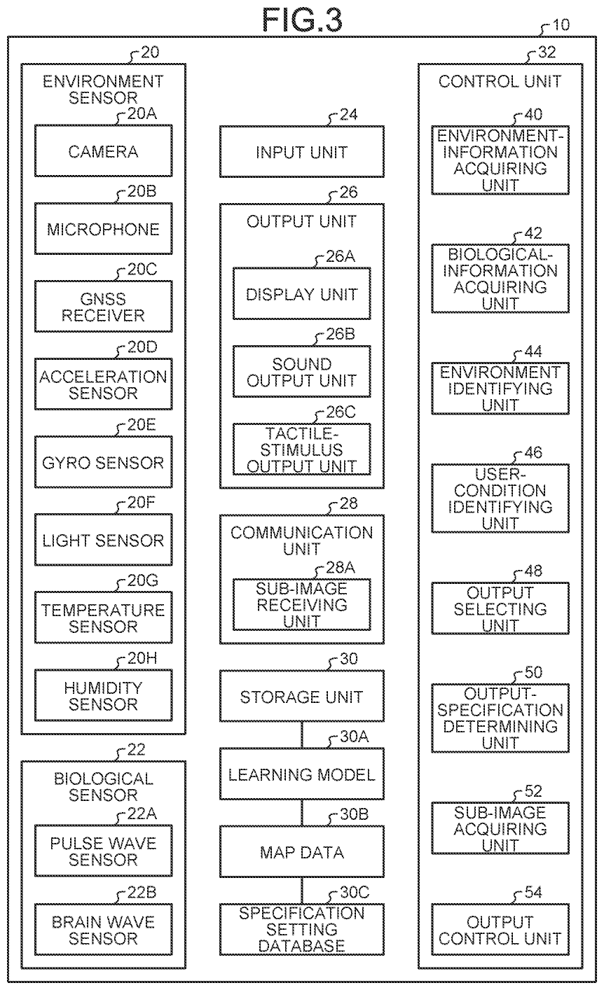

FIG. 3 is a schematic block diagram of the display device according to the present embodiment. As illustrated in FIG. 3, the display device 10 includes an environment sensor 20, a biological sensor 22, an input unit 24, an output unit 26, a communication unit 28, a storage unit 30, and a control unit 32.

Environment Sensor

The environment sensor 20 is a sensor that detects environment information around the display device 10. The environment information around the display device 10 is also regarded as information that indicates what environment the display device 10 is in. Moreover, because the display device 10 is mounted on the user U, it can also be said that the environment sensor 20 detects environment information around the user U.

The environment sensor 20 includes the camera 20A, a microphone 20B, a GNSS receiver 20C, an acceleration sensor 20D, a gyro sensor 20E, a light sensor 20F, a temperature sensor 20G, and a humidity sensor 20H. Note that the environment sensor 20 may include any sensor that detects environment information, and it may be one including at least one of the camera 20A, the microphone 20B, the GNSS receiver 20C, the acceleration sensor 20D, the gyro sensor 20E, the light sensor 20F, the temperature sensor 20G, and the humidity sensor 20H, or may be one including other sensors.

The camera 20A is an imaging device, and images a periphery of the display device 10 as the environment information by detecting visible light around the display device 10 (the user U). The camera 20A may be a video camera that images at a predetermined frame rate. In the display device 10, the camera 20A may be arranged at an arbitrary position and in an arbitrary orientation, but the camera 20A is arranged in the device 10A illustrated in FIG. 1, and may be arranged such that an imaging direction is a direction in which the face of the user U faces. Thus, the camera 20A can image a target object that is present in a direction in which the user U is looking, that is, in in a field of view of the user U. Moreover, the number of the camera 20A is arbitrarily determined, and it may be one or more. When the camera 20A is provided in plurality, information of a direction in which the cameras 20A are directed is also acquired.

The microphone 20B is a microphone that detects sound (sound wave information) around the display device 10 (the user U) as the environment information. In the display device 10, the microphone 20B may be arranged at an arbitrary position, in an arbitrary orientation, and in an arbitrary number. When the microphone 20B is provided in plurality, information of a direction in which the microphones 20B are directed is also acquired.

The GNSS receiver 20C is a device that detects position information of the display device 10 (the user U) as the environment information. The position information herein is terrestrial coordinates. In the present embodiment, the GNSS receiver 20C is a so-called global navigation satellite system (GNSS) module, and receives a radio wave from a satellite to detect position information of the display device 10 (the user U).

The acceleration sensor 20D is a sensor that detects an acceleration degree of the display device 10 (the user U) as the environment information, and detects, for example, gravity, vibration, impact, and the like.

The gyro sensor 20E is a sensor that detects a rotation and an orientation of the display device 10 (the user U) as the environment information, and performs detection by using the Coriolis force, the Euler force, the centrifugal force, and the like.

The light sensor 20F is a sensor that detects intensity of light around the display device 10 (the user U) as the environment information. The light sensor 20F can detect the intensity of visible light, infrared ray, and ultraviolet ray.

The temperature sensor 20G is a sensor that detects temperature of periphery of the display device 10 (the user U) as the environment information.

The humidity sensor 20H is a sensor that detects humidity of periphery of the display device 10 (the user U) as the environment information.

Biological Sensor

The biological sensor 22 is a sensor that detects biological information of the user U. The biological sensor 22 may be arranged at arbitrary position as long as biological information of the user U can be detected. The biological information herein is not non-changing information, such as finger print, but is preferable to be, for example, information, a value of which changes according to the condition of the user U. More specifically, the biological information herein is preferable to be information relating to autonomic nerves, that is, information in which a value changes irrespective of intension of the user U. Specifically, the biological sensor 22 includes a pulse wave sensor 22A and a brain wave sensor 22B, and detects a pulse wave and a brain wave of the user U as the biological information.

The pulse wave sensor 22A is a sensor that detects a brain wave of the user U. The pulse wave sensor 22A may be a sensor of a transmission photoelectric system that includes a light emitting unit and a light receiving unit. In this case, the pulse wave sensor 22A has, for example, a structure in which the light emitting unit and the light receiving unit oppose to each other, sandwiching a fingertip of the user U, and the light receiving unit receives light that has passed through the fingertip, and may measure a waveform of pulses by using a phenomenon that a blood flow increases as a pressure of a pulse wave becomes large. However, the pulse wave sensor 22A is not limited thereto, but may be of any system enabling to detect a pulse wave.

The brain wave sensor 22B is a sensor that detects a brain wave of the user U. The brain wave sensor 22B may have arbitrary configuration as long as a brain wave of the user U can be detected, but theoretically, it is sufficient as long as an α wave and a β wave, and basic rhythmic (background brain wave) activity that appears in the entire brain can be grasped, and improvement and deterioration of activity as the entire brain can be detected and, therefore, several units are enough to be arranged. Because it is necessary to measure only rough changes in condition of the user U in the present embodiment unlike brain wave measurement for medical purposes, for example, only two electrodes may be mounted at the forehead and an ear, and very simple surface brain wave may be detected.

The biological sensor 22 is not limited to be configured to detect a pulse wave and a brain wave as the biological information, but may detect, for example, at least one of the pulse wave and the brain wave. Furthermore, the biological sensor 22 may detect ones other than a pulse wave and a brain wave as the biological information, and may detect, for example, an amount of sweating, the size of the pupils, and the like.

Input Unit

The input unit 24 is a device that accepts an operation by a user, and is, for example, a touch panel and the like.

Output Unit

The output unit 26 is a device that outputs a stimulus to at least one of five senses to the user U.

Specifically, the output unit 26 includes the display unit 26A, the sound output unit 26B, and the tactile-stimulus output unit 26C. The display unit 26A is a display that outputs a visual stimulus for the user U by displaying an image, and can also be referred to as visual-stimulus output unit. In the present embodiment, the display unit 26A is a so-called head mount display (HMD). The display unit 26A displays the sub-image PS so as to be superimposed on the main image PM as described above. The sound output unit 26B is a device (speaker) that outputs audio stimulus for the user U by outputting sound, and can also be referred to as audio-stimulus output unit. The tactile-stimulus output unit 26C is a device that outputs a tactile stimulus for the user U. For example, the tactile-stimulus output unit 26C outputs a tactile stimulus by physical action, such as vibration, but the kind of the tactile stimulus is not limited to vibration and the like, and may be any kinds.

As described, the output unit 26 stimulates the sense of sight, the sense of hearing, and the sense of touch out of five sense of humans. However, the output unit 26 is not limited to output visual stimulus, audio stimulus, and tactile stimulus. For example, the output unit 26 may be configured to output at least one of a visual stimulus, an audio stimulus, and a tactile stimulus, may be configured to output at least a visual stimulus (display an image), may be configured to output either one of an audio stimulus and a tactile stimulus I addition to a visual stimulus, or may be configured to output another sensing stimulus out of five senses (that is, at least one of a taste stimulus and a olfactory stimulus) in addition to at least one out of a visual stimulus, an audio stimulus, and a tactile stimulus.

Communication Unit

The communication unit 28 is a module to communicate with an external device, and may include, for example, an antenna and the like. A communication method by the communication unit 28 is wireless communication in the present embodiment, but the communication method may be any method. The communication unit 28 includes a sub-image receiving unit 28A. The sub-image receiving unit 28A is a receiver that receives sub-image data that is image data of a sub-image. Contents displayed in a sub-image can include a sound and a tactile stimulus. In this case, the sub-image receiving unit 28A may receive sound data and tactile stimulus data together with image data of a sub-image, as the sub-image data. Moreover, when the display unit 26A displays a content image other than a sub-image described above, the communication unit 28 receives image data of the content image also.

Storage Unit

The storage unit 30 is a memory that stores various kinds of information, such as a calculation content of the control unit 32 and a computer program, and includes, for example, at least one of a main storage device, such as a random access memory (RAM) and a read only memory (ROM), and an external storage device, such as a hard disk drive (HDD).

The storage unit 30 stores a learning model 30A, map data 30B, and a specification setting database 30C. The learning model 30A is an AI model that is used to identify an environment by which the user U is surrounded based on the environment information. The map data 30B is data including position information, such as a building structure and a natural object that actually exist, and can be regarded as data in which terrestrial coordinates and a building structure, a natural object, and the like that actually exit are associated with each other. The specification setting database 30C is a database that includes information to determine a display specification of the sub-image PS as described later. Processing using the learning model 30A, the map data 30B, the specification setting database 30C, and the like will be described later. The learning model 30A, the map data 30B, the specification setting database 30C, and a computer program for the control unit 32 stored in the storage unit 30 may be stored in a recording medium that can be read by the display device 10. Moreover, a computer program for the control unit 32 stored in the storage unit 30, the learning model 30A, the map data 30B, and the specification setting database 30C are not limited to be stored in the storage unit 30 in advance, but may be acquired from an external device by the display device 10 by communication at the time when these pieces of data are used.

Control Unit

The control unit 32 is an arithmetic device, that is, a central processing unit (CPU). The control unit 32 includes an environment-information acquiring unit 40, a biological-information acquiring unit 42, an environment identifying unit 44, a user-condition identifying unit 46, an output selecting unit 48, an output-specification determining unit 50, a sub-image acquiring unit 52, and an output control unit 54. The control unit 32 reads and executes computer programs (software) from the storage unit 30 to implement the environment-information acquiring unit 40, the biological-information acquiring unit 42, the environment identifying unit 44, the user-condition identifying unit 46, the output selecting unit 48, the output-specification determining unit 50, the sub-image acquiring unit 52, and the output control unit 54, and performs processing of those. The control unit 32 may perform the processing by a single CPU, or may include plural CPUs to perform the processing by the plural CPUs. Moreover, at least one of the environment-information acquiring unit 40, the biological-information acquiring unit 42, the environment identifying unit 44, the user-condition identifying unit 46, the output selecting unit 48, the output-specification determining unit 50, the sub-image acquiring unit 52, and the output control unit 54 may be implemented by hardware.

The environment-information acquiring unit 40 controls the environment sensor 20, to cause the environment sensor 20 to detect environment information. The environment-information acquiring unit 40 acquires the environment information detected by the environment sensor 20. Processing of the environment-information acquiring unit 40 will be described later. When the environment-information acquiring unit 40 is hardware, it can also be referred to as environment information detector.

The biological-information acquiring unit 42 controls the biological sensor 22, to cause the biological sensor 22 to detect biological information. The biological-information acquiring unit 42 acquires the biological information detected by the biological sensor 22. Processing of the biological-information acquiring unit 42 will be described later. When the biological-information acquiring unit 42 is hardware, it can also be referred to as biological information detector.

The environment identifying unit 44 identifies an environment by which the user U is surrounded base on the environment information acquired by the environment-information acquiring unit 40. The environment identifying unit 44 calculates an environment score that is a score to identify an environment, and identifies an environment state pattern indicating a state of the environment based on the environment score, and thereby identifies the environment. Processing of the environment identifying unit 44 will be described later.

The user-condition identifying unit 46 identifies the condition of the user U based on the biological information acquired by the biological-information acquiring unit 42. Processing of the user-condition identifying unit 46 will be described later.

The output selecting unit 48 selects a target device to be actuated in the output unit 26 based on at least one of the environment information acquired by the environment-information acquiring unit 40 and the biological information acquired by the biological-information acquiring unit 42. Processing of the output selecting unit 48 will be described later. When the output selecting unit 48 is hardware, it may also be referred to as sense selector.

The output-specification determining unit 50 determines an output specification of a stimulus (visual stimulus, audio stimulus, tactile stimulus in this example) output by the output unit 26 based on at least one of the environment information acquired by the environment-information acquiring unit 40 and the biological information acquired by the biological-information acquiring unit 42. It is also, for example, regarded that the output-specification determining unit 50 determines a display specification (output specification) of the sub-image PS that is displayed by the display unit 26A based on at least one of the environment information acquired by the environment-information acquiring unit 40 and the biological information acquired by the biological-information acquiring unit 42. The output specification is an index indicating how a stimulus output by the output unit 26 is to be output, and details are described later. Processing of the output-specification determining unit 50 will be described later.

The sub-image acquiring unit 52 acquires sub-image data through the sub-image receiving unit 28A.

The output control unit 54 controls the output unit 26 to perform output. The output control unit 54 causes a target device selected by the output selecting unit 48 to perform output in an output specification that has been determined by the output-specification determining unit 50. For example, the output control unit 54 controls the display unit 26A to superimpose the sub-image PS acquired by the sub-image acquiring unit 52 on the main image PM, and to display in a display specification determined by the output-specification determining unit 50. When the output control unit 54 is hardware, it may also be referred to as multisensory sense provider.

The display device 10 has a configuration as explained above.

Processing

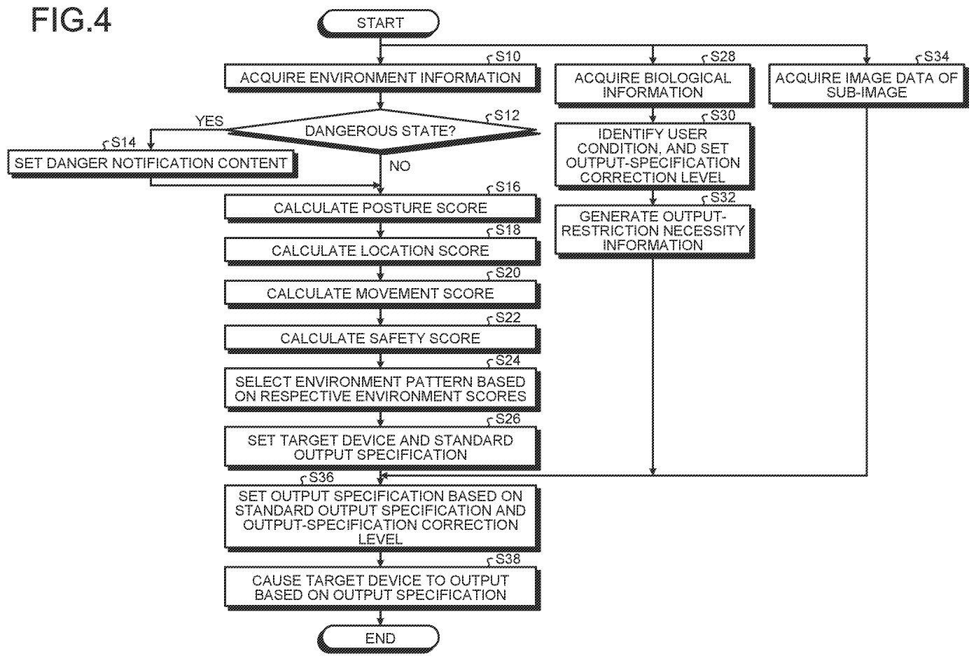

Next, Processing performed by the display device 10, more specifically, processing of causing the output unit 26 to output based on the environment information and the biological information will be explained. FIG. 4 is a flowchart explaining the processing of the display device according to the first embodiment.

Acquisition of Environment Information

As illustrated in FIG. 4, the display device 10 acquires, by the environment-information acquiring unit 40, environment information detected by the environment sensor 20 (step S10). In the present embodiment, the environment-information acquiring unit 40 acquires image data in which a periphery of the display device 10 (the user U) is captured from the camera 20A, acquires sound data of the periphery of the display device 10 (the user U) from the microphone 20B, acquires position information of the display device 10 (the user U) from the GNSS receiver 20C, acquires acceleration information of the display device 10 (the user U) from the acceleration sensor 20D, acquires orientation information, that is, the posture information of the display device 10 (the user U) from the gyro sensor 20E, acquires intensity information of infrared ray and ultraviolet ray around the display device 10 (the user U) from the light sensor 20F, acquires temperature information of the periphery of the display device (the user U) from the temperature sensor 20G, and acquires humidity information of the periphery of the display device 10 (the user U) from the humidity sensor 20H. The environment-information acquiring unit 40 sequentially acquires these kinds of environment information every predetermined period. The environment-information acquiring unit 40 may acquire the respective environment information at the same time, or may acquire the respective environment information at different times. Moreover, the predetermined period until next environment information is acquired may be arbitrarily set, and the predetermined period may be the same or different for each environment information.

Determination of Dangerous State

Having acquired the environment information, the display device 10 determines whether an environment of the periphery of the user U is in a dangerous state based on the environment information by the environment identifying unit 44 (step S12).

The environment identifying unit 44 determines whether it is in a dangerous state based on an image of the periphery of the display device 10 captured by the camera 20A. Hereinafter, the image of the periphery of the display device 10 captured by the camera 20A will be denoted as periphery image as appropriate. For example, the environment identifying unit 44 identifies an object shown in the periphery image, and determines whether it is in a dangerous state based on a type of the identified object. More specifically, the environment identifying unit 44 may determine that it is in a dangerous state when an object shown in the periphery image is a specific object defined in advance, and may determine that it is not in a dangerous state when the object is not the specific object. The specific object may be arbitrarily defined, and may be an object that can cause a danger for the user U, such as, a flame indicating fire, a vehicle, and a signage indicating that there is construction. Moreover, the environment identifying unit 44 may determine whether it is in a dangerous state based on plural periphery images that are captured chronologically sequentially. For example, the environment identifying unit 44 identifies an object for each of plural periphery images that are chronologically sequentially captured, and determines whether those objects are a specific object and are identical object. When the same specific object is shown, the environment identifying unit 44 determines whether the specific object shown in a periphery image captured later in chronological order is relatively larger in the image, that is, whether the specific object is becoming closer to the user U. The environment identifying unit 44 determines that it is in a dangerous state when the specific object shown in the periphery image captured later is larger, that is, when the specific object is becoming closer to the user U. On the other hand, the environment identifying unit 44 determines that it is not in a dangerous state when the specific object shown in the periphery image captured later is not larger, that is, when the specific object is not becoming closer to the user U. As described, the environment identifying unit 44 may determine whether it is in a dangerous state based on one periphery image, or may determine whether it is in a dangerous state based on plural periphery images sequentially captured in chronologically. For example, the environment identifying unit 44 may switch determination methods according to a type of object shown in the periphery image. The environment identifying unit 44 may determine that it is in a dangerous state from a single periphery image when a specific object that enables determination of danger from a single periphery image, such as a flame indicating fire, is shown. Furthermore, the environment identifying unit 44 may perform determination of a dangerous state based on plural periphery images chronologically sequentially captured when a specific object from which determination of danger is not possible from a single periphery image, such as a vehicle, is shown.

The environment identifying unit 44 may perform identification of an object shown in the periphery image by an arbitrary method and, for example, may identify an object by using the learning model 30A. In this case, for example, the learning model 30A is an AI model in which data of an image and information indicating a type of object shown in the image are one data set, and that is constructed by performing learning with plural data sets as learning data. The environment identifying unit 44 inputs image data of the periphery image into the learned learning model 30A, and acquires information identifying a type of the object shown in the periphery image, to perform identification of the object.

Moreover, the environment identifying unit 44 may determine whether it is in a dangerous state based on position information acquired by the GNSS receiver 20C in addition to the periphery image. In this case, the environment identifying unit 44 acquires location information indicating a location of the user U based on the position information of the display device 10 (the user U) acquired by the GNSS receiver 20C, and the map data 30B. The location information is information indicating at what kind of place the user U (the display device 10) is located. That is, the location information is information indicating that the user U is in a shopping center, or information indicating that he/she is on a street. The environment identifying unit 44 reads out the map data 30B, and identifies a type of a structural object or a natural object within a predetermined distance range for a current position of the user U, and identifies the location information from the structural object and the natural object. For example, when a current position of the user U overlaps coordinates of a shopping center, it is identified that the user U is at the shopping center as the location information. The environment identifying unit 44 determines that it is in a dangerous state when the location information and the type of the object identified from the periphery image are in a specific relationship, and determines that it is not in a dangerous state when not in the specific relationship. The specific relationship may be arbitrarily defined but, for example, a combination of an object and a location that can cause a danger when the object is present at one location may be defined as the specific relationship.

Moreover, the environment identifying unit 44 determines whether it is in a dangerous state based on sound information acquired by the microphone 20B. Hereinafter, the sound information of the periphery of the display device 10 acquired by the microphone 20B is denoted as periphery sound as appropriate. For example, the environment identifying unit 44 identifies a type of sound included in the periphery sound, and determines whether it is in a dangerous state based on the identified type of sound. More specifically, the environment identifying unit 44 may determine that it is in a dangerous state when the type if sound included in the periphery sound is a specific sound defined in advance, and may determine that it is not in a dangerous state when it is not the specific sound. The specific sound may be arbitrarily defined and, for example, may be a sound that can cause a danger for the user U, such as a sound indicating fire, a sound of a vehicle, and a sound indicating construction.

The environment identifying unit 44 may perform identification of a type of sound included in the periphery sound by any method but, for example, may identify an object by using the learning model 30A. In this case, for example, the learning model 30A is an AI model in which sound data (for example, data indicating a frequency and a strength of sound) and information indicating a type of the sound are one data set, and that is constructed by performing learning with plural data sets as learning data. The environment identifying unit 44 inputs sound data of the periphery sound into the learned learning model 30A, and acquires information identifying a type of sound included in the periphery sound, to perform identification of the type of the sound.

Moreover, the environment identifying unit 44 may determine whether it is in a dangerous state based on position information acquired by the GNSS receiver 20C in addition to the periphery sound. In this case, the environment identifying unit 44 acquires location information indicating a location of the user U based on the position information of the display device 10 (the user U) acquired by the GNSS receiver 20C, and the map data 30B. The environment identifying unit 44 determines that it is in a dangerous state when the location information and the type of sound identified from the periphery sound are in a specific relationship, and determines that it is not in a dangerous state when not in the specific relationship. The specific relationship may be arbitrarily defined but, for example, a combination of a sound and a location that can cause a danger when the sound occurs at one location may be defined as the specific relationship.

As described, in the present embodiment, the environment identifying unit 44 determines a dangerous state based on the periphery image and the periphery sound. However, the determination method of a dangerous state is not limited to the above method but is arbitrary, and the environment identifying unit 44 may determine a dangerous state, for example, based on either one of the periphery image and the periphery sound. Moreover, the environment identifying unit 44 may determine a dangerous state based on at least one of an image of the periphery of the display device 10 captured by the camera 20A, a sound of the periphery of the display device 10 detected by the microphone 20B, and location information acquired by the GNSS receiver 20C. Furthermore, in the present embodiment, determination of a dangerous state is not essential, and may be omitted to be performed.

Setting of Danger Notification Content

When it is determined as a dangerous state (step S12: YES), the display device 10 sets a danger notification content that is a notification content to notify that it is in a dangerous state by the output control unit 54 (step S14). The display device 10 sets the danger notification content based on details of the dangerous state. The details of the danger state are information indicating what kind of danger is arising, and are identified from a type of object shown in a periphery image, a type of sound included in a periphery sound, and the like. For example, when the object is a vehicle and is approaching, details of the dangerous state is to be that “vehicle is approaching”. The danger notification content is information indicating the details of the dangerous state. For example, when details of the dangerous state are approaching vehicle, the danger notification content is to be information indicating that a vehicle is approaching.

The danger notification content varies according to a type of a target device selected at step S26 described later. For example, when the display unit 26A is the target device, the danger notification content is to be a display content (contents) of the sub-image PS. That is, the danger notification content is displayed as the sub-image PS superimposed on the main image PM. In this case, for example, the danger notification content is to be image data indicating a content that “Be careful as a vehicle is approaching”. On the other hand, when the sound output unit 26B is the target device, the danger notification content is a sound content output from the sound output unit 26B. In this case, for example, the danger notification content is to be sound data to output a sound, “A vehicle is approaching. Be careful”. Moreover, when the tactile-stimulus output unit 26C is the target device, the danger notification content is to be a tactile stimulus content output from the tactile-stimulus output unit 26C. In this case, for example, the danger notification content is to be a tactile stimulus of drawing attention of the user U.

The setting of the danger notification content of step S14 may be performed at any time after it is determined that it is in a dangerous state at step S12 and before the danger notification content is output at step S38 of a later stage, and may be performed, for example, after the target device is selected at step S32 of a later stage.

Calculation of Environment Score

When it is determined that it is not in a dangerous state (step S12: NO), the display device 10 calculates various kinds of environment scores based on the environment information by the environment identifying unit 44 as indicated at step S16 to step S22. The environment score is a score to identify an environment by which the user U (the display device 10) is surrounded. Specifically, the environment identifying unit 44 calculates a posture score (step S16), calculates a location score (step S18), calculates a movement score (step S20), and calculates a safety score (step S22) as the environment score. Order from step S16 to step S22 is not limited thereto, and is arbitrary. Also when the danger notification content is set at step S14, the respective kinds of environment scores are calculated as indicated at step S16 to step S22. In the following, the environment score will be specifically explained.

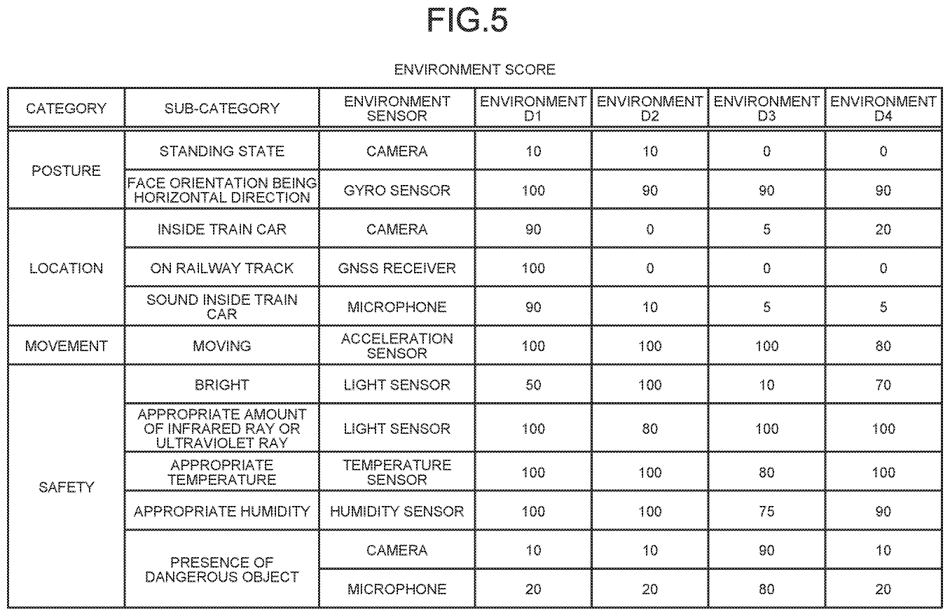

FIG. 5 is a table explaining an example of the environment score. As illustrated in FIG. 5, the environment identifying unit 44 calculates an environment score for each environment category. The environment category indicates a type of an environment of the user U, and the example in FIG. 5 includes a posture of the user U, a location of the user U, movement of the user U, and a safety of the user U in an environment surrounding the user U. Moreover, the environment identifying unit 44 classifies the environment category into more specific sub-categories, and calculates the environment score for each sub-category.

Posture Score

The environment identifying unit 44 calculates a posture score as the environment score for a category of posture of the user U. That is, the posture score is information indicating a posture of the user U, and it can be regarded as information indicating what posture the user U is in as a numerical value. The environment identifying unit 44 calculates the posture score based on environment information relating to the posture of the user U out of plural types of environment information. The environment information relating to the posture of the user U includes the periphery image captured by the camera 20A and the orientation of the display device 10 detected by the gyro sensor 20E.

More specifically, in the example in FIG. 5, the category of posture of the user U includes a sub-category of standing state and a sub-category of face orientation being horizontal direction. The environment identifying unit 44 calculates the posture score for the sub-category of standing state based on the periphery image acquired by the camera 20A. The posture score for the sub-category of standing state can be regarded as a numerical value indicating a degree of match of the posture of the user U with the standing state. A calculation method of the posture score for the sub-category of standing state may be arbitrary and, for example, calculation may be performed by using the learning model 30A. In this case, for example, the learning model 30A is an AI model in which image data of scenery seen in the field of view of a person and information indicating whether the person is standing are one data set, and that is constructed by performing learning with plural data sets as learning data. The environment identifying unit 44 inputs image data of the periphery image into the learned learning model 30A, and acquires a numerical value indicating a degree of match with the standing state, to acquire the posture score. Although the degree of match with the standing state is considered in this example, not limited to the standing state but, for example, a degree of match with a sitting state, a lying state, or the like may be considered.

Furthermore, the environment identifying unit 44 calculates the posture score for the sub-category of face orientation being horizontal direction based on an orientation of the display device 10 detected by the gyro sensor 20E. The posture score for the sub-category of face orientation being horizontal direction can be regarded as a numerical value indicating a degree of match with the horizontal direction of the posture (orientation of the face) of the user U. The calculation method of the posture score for the sub-category of face orientation being horizontal direction may be arbitrary. In this example, the degree of match with the face orientation being horizontal direction is considered, but a degree of match with it being in any direction may be considered.

As described, it is regarded that the environment identifying unit 44 sets information indicating the posture of the user U (the posture score in this example) based on the periphery image and the orientation of the display device 10. However, the environment identifying unit 44 is not limited to use the periphery image and the orientation of the display device 10 to set information indicating the posture of the user U, but may use arbitrary environment information, and may use, for example, at least one of the periphery image and the orientation of the display device 10.

Location Score

The environment identifying unit 44 calculates a location score as the environment score for a category of location of the user U. That is, the location score is information indicating a location of the user U, and it can be regarded as information indicating what kind of place the user U is positioned at as a numerical value. The environment identifying unit 44 calculates the location score based on environment information relating to the location of the user U out of plural types of environment information. The environment information relating to the location of the user U includes the periphery image captured by the camera 20A, the position information of the display device 10 acquired by the GNSS receiver 20C, and the periphery sound acquired by the microphone 20B.

More specifically, in the example in FIG. 5, the category of location of the user U includes a sub-category of inside train car, a sub-category of on railway track, and a sub-category of sound inside train car. The environment identifying unit 44 calculates the location score for the sub-category of inside train car based on the periphery image acquired by the camera 20A. The location score for the sub-category of inside train car can be regarded as a numerical value indicating a degree of match of the location of the user U with the place being inside a train car. A calculation method of the location score for the sub-category of inside train car may be arbitrary and, for example, calculation may be performed by using the learning model 30A. In this case, for example, the learning model 30A is an AI model in which image data of scenery seen in the field of view of a person and information indicating whether the person is inside a train car are one data set, and that is constructed by performing learning with plural data sets as learning data. The environment identifying unit 44 inputs image data of the periphery image into the learned learning model 30A, and acquires a numerical value indicating a degree of match with the location being on a train, to acquire the location score. Although the degree of match with the location being inside a train car is considered in this example, not limited thereto, for example, a degree of match with being inside any type of car may be calculated.

The environment identifying unit 44 calculates the location score for the sub-category of on railway track based on the position information of the display device 10 acquired by the GNSS receiver 20C. The location score for the sub-category of on railway track can be regarded as a numerical value indicating a degree of match of the location of the user U with the location being on a railway track. The calculation method of the location score for the sub-category of on railway track may be arbitrary but, for example, the map data 30B may be used. For example, the environment identifying unit 44 reads out the map data 30B, and calculate the location score such that the degree of match of the location of the user U with the location being on a railway track becomes high when a current position of the user overlaps coordinates of a railway track. In this example, the degree of match with a location on a railway track is calculated but, not limited thereto, a degree of match with a position of any kind of structural object, a natural object, and the like may be calculated.

The environment identifying unit 44 calculates the location score for the sub-category of sound inside train car based on the periphery sound acquired by the microphone 20B. The location score for the sub-category of sound inside train car can be regarded as a numerical value indicating a degree of match of the periphery sound with a sound inside a train car. A calculation method of the location score for the sub-category of sound inside train car may be arbitrary but, for example, it may be determined by a method similar to the method of determining whether it is in a dangerous state based on the periphery sound as described above, that is, by determining whether the periphery sound is a specific type of sound. Although the degree of match with the sound inside a train car is calculated in this example, not limited thereto, a degree of match with sound of any place may be calculated.

As described, it is regarded that the environment identifying unit 44 sets information indicating the location of the user U (the location score in this example) based on the periphery image, the periphery sound, and the position information of the display device 10. However, the environment identifying unit 44 is not limited to use the periphery image, the periphery sound, and the position information of the display device 10 to set information indicating the location of the user U, but may use arbitrary environment information, and may use, for example, at least one of the periphery image, the periphery sound, and the position information of the display device 10.

Movement Score

The environment identifying unit 44 calculates a movement score as the environment score for a category of movement of the user U. That is, the movement score is information indicating a movement of the user U, and it can be regarded as information indicating how the user U is moving as a numerical value. The environment identifying unit 44 calculates the movement score based on environment information relating to the movement of the user U out of plural types of environment information. The environment information relating to the movement of the user U includes the acceleration information acquired by the acceleration sensor 20D.

More specifically, in the example in FIG. 5, the category of movement of the user U includes a sub-category of moving. The environment identifying unit 44 calculates the movement score for the sub-category of moving based on the acceleration information of the display device 10 acquired by the acceleration sensor 20D. The movement score for the sub-category of moving can be regarded as a numerical value indicating a degree of match of a current state of the user U with a moving state of the user U. A calculation method of the movement score for the sub-category of moving state may be arbitrary, and the movement score may be calculated, for example, from variation in acceleration in a predetermined period. For example, the movement score is calculated such that the degree of match with a state that the user U is moving becomes high when the acceleration varies in the predetermined period. Moreover, for example, the movement score may be calculated based on a degree of change in position in the predetermined period by acquiring the position information of the display device 10. In this case, from an amount of change in position in the predetermined period, the speed can be estimated, and a means of mobility, such as vehicle and foot, can also be identified. Although the degree of match with a moving state is calculated in this example, not limited thereto, for example, a degree of match with a state moving at a predetermined speed may be calculated.

As described, it is regarded that the environment identifying unit 44 sets information indicating the movement of the user U (the movement score in this example) based on the acceleration information of the display device 10 and the position information of the display device 10. However, the environment identifying unit 44 is not limited to use the acceleration information and the position information to set information indicating the movement of the user U, but may use arbitrary environment information, and may use, for example, at least one of the acceleration information and the position information.

Safety Score

The environment identifying unit 44 calculates a safety score as the environment score for a category of safety of the user U. That is, the safety score is information indicating safety of the user U, and it can be regarded as information indicating whether the user U is in a safe environment as a numerical value. The environment identifying unit 44 calculates the safety score based on environment information relating to the safety of the user U out of plural types of environment information. The environment information relating to the safety of the user U includes the periphery image captured by the camera 20A, the periphery sound acquired by the microphone 20B, the intensity information of light detected by the light sensor 20F, the temperature information of the periphery detected by the temperature sensor 20G, and the humidity information of the periphery detected by the humidity sensor 20H.

More specifically, in the example in FIG. 5, the category of safety of the user U includes a sub-category of bright, a sub-category of appropriate amount of infrared ray or ultraviolet ray, a sub-category of appropriate temperature, a sub-category of appropriate humidity, and a sub-category of presence of a dangerous object. The environment identifying unit 44 calculates the safety score for the sub-category of bright based on the intensity of visible light in the periphery acquired by the light sensor 20F. The safety score for the sub-category of bright can be regarded as a numerical value indicating a degree of match of brightness of the periphery with sufficient brightness. A calculation method of the safety score for the sub-category of bright may be arbitrary and, for example, calculation may be performed by using the intensity of visible light detected by the light sensor 20F. Moreover, for example, the safety score for the sub-category of bright may be calculated based on brightness of the image captured by the camera 20A. Although the degree of match with sufficient brightness is calculated in this example, not limited thereto, a degree of match with a degree of arbitrary brightness may be calculated.

The environment identifying unit 44 calculates the safety score for the sub-category of appropriate amount of infrared ray or ultraviolet ray based on the intensity of infrared ray and ultraviolet ray in the periphery acquired by the light sensor 20F. The safety score for the sub-category of appropriate amount of infrared ray or ultraviolet ray can be regarded as a numerical value indicating a degree of match of intensity of infrared ray or ultraviolet ray in the periphery with an appropriate intensity of infrared ray or ultraviolet ray. A calculation method of the safety score for the sub-category of appropriate amount of infrared ray or ultraviolet ray may be arbitrary and, for example, calculation may be performed by using the intensity of infrared ray or ultraviolet ray detected by the light sensor 20F. Although the degree of match with an appropriate intensity of infrared ray or ultraviolet ray is calculated in this example, not limited thereto, for example, a degree of match with an arbitrary intensity of infrared ray or ultraviolet ray may be calculated.

The environment identifying unit 44 calculates the safety score for the sub-category of appropriate temperature based on temperature of the periphery acquired by the temperature sensor 20G. The safety score for the sub-category of appropriate temperature can be regarded as a numerical value indicating a degree of match of the temperature of the periphery with an appropriate temperature. A calculation method of the safety score for the sub-category of appropriate temperature may be arbitrary and, for example, calculation may be performed based on temperature of the periphery detected by the temperature sensor 20G. Although the degree of match with appropriate temperature is calculated in this example, not limited thereto, a degree of match with arbitrary temperature may be calculated.

The environment identifying unit 44 calculates the safety score for the sub-category of appropriate humidity based on humidity of the periphery acquired by the humidity sensor 20H. The safety score for the sub-category of appropriate humidity can be regarded as a numerical value indicating a degree of match of the humidity of the periphery with an appropriate humidity. A calculation method of the safety score for the sub-category of appropriate humidity may be arbitrary and, for example, calculation may be performed based on the humidity of the periphery detected by the humidity sensor 20H. Although the degree of match with an appropriate humidity is calculated in this example, not limited thereto, a degree of match with arbitrary humidity may be calculated.

The environment identifying unit 44 calculates the safety score for the sub-category of presence of a dangerous object based on the periphery image acquired by the camera 20A. The safety score for the sub-category of presence of a dangerous object can be regarded as a numerical value indicating a degree of match with presence of a dangerous object. A calculation method of the safety score for the sub-category of presence of a dangerous object may be arbitrary and, for example, it may be determined by a method similar to the method of determining whether it is in a dangerous state based on the periphery image as described above, that is, by determining whether an object included in the periphery image is a specific object. Furthermore, the environment identifying unit 44 calculates the safety score for the sub-category of presence of a dangerous object based on the periphery sound acquired by the microphone 20B also. A calculation method of the safety score for the sub-category of presence of a dangerous object may be arbitrary and, for example, it may be determined by a method similar to the method of determining whether it is in a dangerous state based on the periphery sound as described above, that is, for example, by determining whether the periphery sound is a specific sound.

One Example of Environment Score

FIG. 5 shows the environment scores calculated for an environment D1 to the environment D4. The environment D1 to the environment D4 respectively indicate cases in which the user U is in respective different environments, and the environment score is calculated for each category (sub-category) in the respective environments.

The kinds of the categories and the sub-categories shown in FIG. 5 are one example, and values of the environment scores in the environment D1 to the environment D4 are also one example. Moreover, by thus expressing information indicating an environment of the user U by a numerical value such as the environment score, the display device 10 can factor in an error and the like, and can estimate an environment of the user U more accurately. In other words, it can be said that by classifying the environment information into either one of three or more degrees (the environment score in this example), the display device 10 can estimate an environment of the user U accurately. However, the information indicating an environment of the user U set by the display device 10 based on the environment information is not limited to a value such as the environment score, but may be any form of data and, for example, it may be information indicating either one of two possible values of Yes and No.

Determination of Environment Pattern

The display device 10 calculates the respective kinds of environment scores by the method explained above at step S16 to step S22 in FIG. 4. As illustrated in FIG. 4, having calculated the environment score, the display device 10 determines an environment pattern indicating an environment by which the user U is surrounded based on the respective environment scores by the environment identifying unit 44 (step S24). That is, the environment identifying unit 44 determines what kind of environment the user U is in based on the environment scores. While the environment information and the environment score are information indicating a partial element of the environment of the user U detected by the environment sensor 20, it can be said that the environment pattern is an index that is set based on the information indicating those partial elements, and that indicates the environment comprehensively.

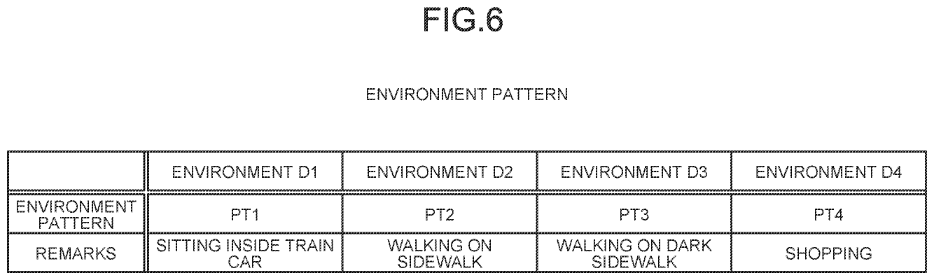

FIG. 6 is a table showing one example of the environment pattern. In the present embodiment, the environment identifying unit 44 selects an environment pattern that match with the environment by which the user U is surrounded from among environment patterns corresponding to various environments, based on the environment score. In the present embodiment, for example, correspondence information (table) in which a value of the environment score and an environment pattern are associated with each other is recorded in the specification setting database 30C. The environment identifying unit 44 determines an environment pattern based on the environment information and this correspondence information. Specifically, the environment identifying unit 44 selects an environment pattern that is associated with a value of the calculated environment score from the correspondence information, to select as an environment pattern to be adopted. In the example in FIG. 6, an environment pattern PT1 indicates that the user U is sitting inside a train car, an environment pattern PT2 indicates that the user U is walking on a sidewalk, an environment pattern PT3 indicates that the user U is walking on a dark sidewalk, and an environment pattern PT4 indicates that the user U is shopping.

In the examples in FIG. 5 and FIG. 6, from the environment score of “STANDING STATE” being 10 and the environment score of “FACE ORIENTATION IS HORIZONTAL DIRECTION” being 100, it can be estimated that the user U is sitting with his/her face directed in a horizontal direction. Moreover, from the environment score of “ON A TRAIN” being 90, the environment score of “ON RAILWAY TRACK” being 100, and the environment score of “SOUND INSIDE TRAIN CAR” being 90, it is understood that the user U is inside a train car. Furthermore, because the environment score of “MOVING” is 100, it is understood that the user U is traveling with a uniform velocity or acceleration. Moreover, the environment score of “BRIGHT” is 50, and it is understood that it is darker than outside because it is in a train. Furthermore, the environment score of “APPROPRIATE AMOUNT OF INFRARED RAY OR ULTRAVIOLET RAY”, “APPROPRIATE TEMPERATURE”, “APPROPRIATE HUMIDITY” is 100, and it is regarded as safe. Moreover, the environment score of “PRESENCE OF DANGEROUS OBJECT” is 10 in terms of image, and 20 in terms of sound, and it is also regarded as safe. That is, for the environment D1, it can be estimated that the user U is inside a train car and is traveling, sitting on a seat, and is in a safe comfortable situation, and the environment pattern of the environment D1 is estimated as the environment pattern PT1 indicating a state of sitting inside a train car.

Furthermore, in the examples in FIG. 5 and FIG. 6, from the environment score of “STANDING STATE” being 10 and the environment score of “FACE ORIENTATION BEING HORIZONTAL DIRECTION” being 90, it can be estimated that the user U is sitting with his/her face directed in a substantially horizontal direction. Moreover, from the environment score of “INSIDE TRAIN CAR” being 0, the environment score of “ON RAILWAY TRACK” being 0, and the environment score of “SOUND INSIDE TRAIN CAR” being 10, it is understood that the user U is not inside a train car. Although illustration is omitted herein, in the environment D2, it is also understood that the user U is on a street based on the environment score of the location. Furthermore, because the environment score of “MOVING” is 100, it is understood that the user U is traveling with a uniform velocity or acceleration. Moreover, the environment score of “BRIGHT” is 100, and it is understood that it is bright outdoor. Furthermore, the environment score of “APPROPRIATE AMOUNT OF INFRARED RAY OR ULTRAVIOLET RAY” is 80, and it is understood that there is a little influence of ultraviolet ray and the like. Moreover, the environment scores of “APPROPRIATE TEMPERATURE”, “APPROPRIATE HUMIDITY” are 100, and it is regarded as safe. Furthermore, the environment score of “PRESENCE OF DANGEROUS OBJECT” is 10 in terms of image, and 20 in terms of sound, and it is also regarded as safe. That is, for the environment D2, it can be estimated that the user U is traveling on foot on a sidewalk, it is bright outdoor, and no dangerous object is recognized, and the environment pattern of the environment D2 is estimated as the environment pattern PT2 indicating a state of walking on a sidewalk.

Furthermore, in the examples in FIG. 5 and FIG. 6, in the environment D3, from the environment score of “STANDING STATE” being 0 and the environment score of “FACE ORIENTATION BEING HORIZONTAL DIRECTION” being 90, it can be estimated that the user U is sitting with his/her face directed in a substantially horizontal direction. Moreover, from the environment score of “INSIDE TRAIN CAR” being 5, the environment score of “ON RAILWAY TRACK” being 0, and the environment score of “SOUND INSIDE TRAIN CAR” being 5, it is understood that the user U is not inside a train car. Although illustration is omitted herein, in the environment D3, it is also understood that the user U is on a street based on the environment score of the location. Furthermore, because the environment score of “MOVING” is 100, it is understood that the user U is traveling with a uniform velocity or acceleration. Moreover, the environment score of “BRIGHT” is 10, and it is understood that it is a dark environment. Furthermore, “APPROPRIATE AMOUNT OF INFRARED RAY OR ULTRAVIOLET RAY” is 100, and it is understood that it is safe. Moreover, the environment score of “APPROPRIATE TEMPERATURE” is 75, and it is regarded warmer or colder than a standard temperature. Furthermore, the environment score of “PRESENCE OF DANGEROUS OBJECT” is 90 in terms of image, and 80 in terms of sound, and it is understood that something is approaching while making a noise. Although not illustrated, the object can be determined from a sound and an image, and it is determined, in this example, that a vehicle is approaching and the noise is an engine noise. That is, for the environment D3, it can be estimated that the user U is traveling on foot on a sidewalk, it is dark outdoor, and a vehicle is approaching as a dangerous object, and the environment pattern of the environment D3 is estimated as the environment pattern PT3 indicating a state of walking on a dark sidewalk.

Furthermore, in the examples in FIG. 5 and FIG. 6, in the environment D4, from the environment score of “STANDING STATE” being 0 and the environment score of “FACE ORIENTATION BEING HORIZONTAL DIRECTION” being 90, it can be estimated that the user U is sitting with his/her face directed in a substantially horizontal direction. Moreover, from the environment score of “INSIDE TRAIN CAR” being 20, the environment score of “ON RAILWAY TRACK” being 0, and the environment score of “SOUND INSIDE TRAIN CAR” being 5, it is understood that the user U is not inside a train car. Although illustration is omitted herein, in the environment D4, it is also understood that the user U is in a shopping center based on the environment score of the location. Furthermore, because the environment score of “MOVING” is 80, it is understood that the user U is traveling slowly. Moreover, the environment score of “BRIGHT” is 70, and it can be estimated that it is relatively bright, but the brightness is at a level of indoor illumination. Furthermore, the environment score of “APPROPRIATE AMOUNT OF INFRARED RAY OR ULTRAVIOLET RAY” is 100, and it is understood that it is safe. Moreover, the environment score of “APPROPRIATE TEMPERATURE” is 100 and it is comfortable, but because the environment score of “APPROPRIATE HUMIDITY” is 90, it is regarded as not completely comfortable. Furthermore, the environment score of “PRESENCE OF DANGEROUS OBJECT” is 10 in terms of image, and 20 in terms of sound, and it is also understood as safe. That is, for the environment D4, it can be estimated from the respective environment scores that the user U is traveling on foot in a shopping center, the periphery is relatively bright, and there is no a dangerous object, and the environment pattern of the environment D4 is estimated as the environment pattern PT4 indicating a state of shopping.

Target Device and Settings of Standard Output Specification

Having selected the environment pattern, the display device 10 selects a target device to be activated from the output unit 26, and sets a standard output specification based on the environment pattern by the output selecting unit 48 and the output-specification determining unit 50 as illustrated in FIG. 4 (step S26).

The target device is a device to be activated in the output unit 26 as described above, and in the present embodiment, the output selecting unit 48 selects the target device from among the display unit 26A, the sound output unit 26B, and the tactile-stimulus output unit 26C based on the environment pattern. Because the environment pattern is information indicating a current environment of the user U, by selecting the target device based on the environment pattern, an appropriate stimulus suitable for the current environment of the user U can be selected.

Moreover, the output-specification determining unit 50 determines a standard output specification, which is an output specification to be a standard, based on the environment pattern. The output specification is an index indicating how to output a stimulus that is output by the output unit 26. For example, the output specification of the display unit 26A is to indicate how to display the sub-image PS to be output, and, it can be stated as display specification also. As the output specification of the display unit 26A, in the present embodiment, display time of the sub-image PS per unit time is included. The output-specification determining unit 50 determines the display time of the sub-image PS per unit time based on the environment pattern. The output-specification determining unit 50 may define the display time of the sub-image PS per unit time by changing time for which the sub-image PS is displayed for one time, may define the display time of the sub-image PS per unit time by changing display frequency of the sub-image PS, or may combine these two. By thus changing the display time of the sub-image PS per unit time, a visual stimulus to be given to the user U can be changed and, for example, it can be said that the longer the display time is, the stronger the visual stimulus to be given to the user U is.

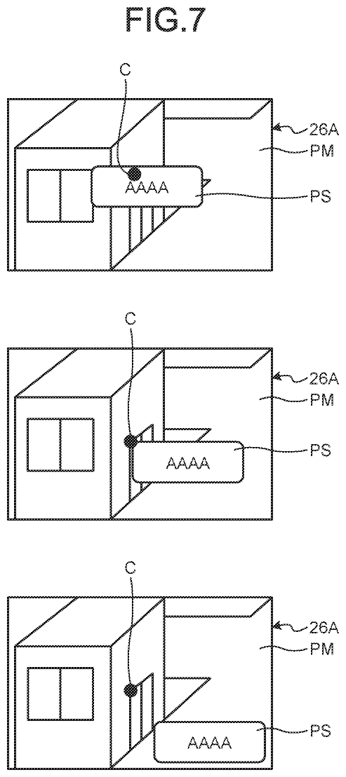

Moreover, as the output specification of the display unit 26A, a display mode indicating how to display the sub-image when it is assumed that the sub-image PS is viewed as a still image is included. The display mode will be explained more specifically. FIG. 7 to FIG. 9 are diagrams illustrating examples when the display mode is changed. As the display mode, for example, a display position of the sub-image PS, that is, a position at which the sub-image PS is displayed in a display screen of the display unit 26A is included. FIG. 7 shows an example in which the display position of the sub-image PS is changed. As illustrated in FIG. 7, because the sub-image PS is displayed, superimposed on the main image PM, the display position of the sub-image PS can be regarded as a relative position of the sub-image PS to the main image PM. Therefore, when the display position of the sub-image PS is changed, a distance between a reference position C of the main image PM and the sub-image PS varies. The reference position C is a center position of the main image PM (the display unit 26A) in this example. By thus changing the display position of the sub-image PS, the degree of visual stimulus to the user U can be changed and, for example, the closer the center of the sub-image PS is to the reference position C, the stronger the degree of visual stimulus to the user U can be made.

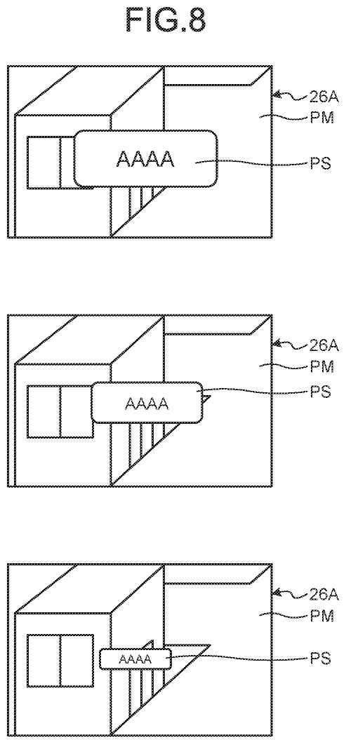

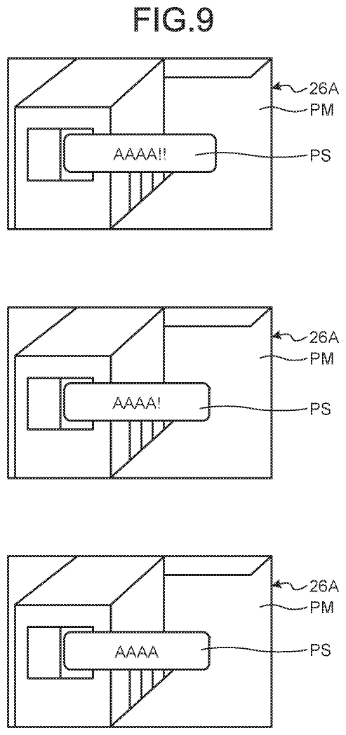

Moreover, as the display mode, a modification that is an image to decorate a content (display content) included in the sub-image PS is included. The modification indicates, in this embodiment, the degree of emphasizing the sub-image PS being an advertisement. In FIG. 8, an example in which the size of the sub-image PS is changed is illustrated as the modification. Furthermore, in FIG. 9, an example in which a modification image to be added to a content of the sub-image PS is present or absent, or in which the modification is changed is illustrated. In the example in FIG. 9, an example in which a modification image “!” for a content (display content) “AAAA” is present or absent, and in which the quantity thereof is changed is shown. A content of the modification image may be arbitrary. By thus changing the modification, the visual stimulus to be given to the user U can be changed and, for example, the larger the sub-image PS is, or the more the modification image is used, the stronger the visual stimulus to the user U can be made.

In the present embodiment, the display position of the sub-image PS and the modification are exemplified as the display mode as described above, but the display mode is not limited thereto, and may be arbitrary. However, the display mode is preferable not to be a content of the sub-image PS, that is, an advertisement content in this example. That is, as the display mode, it is preferable that the content of the sub-image PS itself be unchanged. When plural kinds of the display mode are assumed, only either one of them may be changed, or the plural kinds of the display mode may be changed.

As described, the output-specification determining unit 50 determines, based on the environment pattern, at least one of the display time of the sub-image PS per unit time and the display mode of the sub-image PS as the output specification of the display unit 26A. That is, the output-specification determining unit 50 may determine both the display time of the sub-image PS per unit time and the display mode of the sub-image PS, or may determine only one of them, as the output specification of the display unit 26A.

The output specification of the display unit 26A is explained in the above, but the output-specification determining unit 50 also determines the output specification of the sound output unit 26B and the tactile-stimulus output unit 26C. As the output specification (sound specification) of the sound output unit 26B, volume, whether a sound effect is applied, and the like are included. The sound effect indicates a special effect, such as surround sound and spatial sound. By making the volume larger, or making the level of a sound effect higher, the degree of the audio stimulus to the user U can be made stronger. Moreover, as the output specification of the tactile-stimulus output unit 26C, strength of the tactile stimulus, frequency of the tactile stimulus, and the like are included. By making the strength or frequency of the tactile stimulus higher, the degree of the tactile stimulus to the user U can be made stronger.

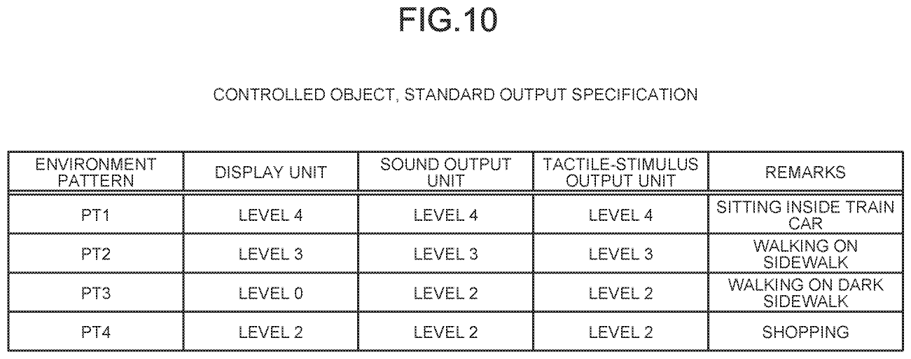

FIG. 10 is a table showing a relationship among an environment pattern, a target device, and a standard output specification. The output selecting unit 48 and the output-specification determining unit 50 determine the target device and the standard output specification based on relationship information indicating a relationship among the environment pattern, the target device, and the standard output specification. The relationship information is information (table) in which the environment pattern, the target device, and the standard output specification are associated to be stored and, for example, is stored in the specification setting database 30C. In the relationship information, for each type of the output unit 26, that is, for each of the display unit 26A, the sound output unit 26B, and the tactile-stimulus output unit 26C in this example, the standard output specification is set. The output selecting unit 48 and the output-specification determining unit 50 determines the target device and the standard output specification based on this relationship information and the environment pattern set by the environment identifying unit 44. Specifically, the output selecting unit 48 and the output-specification determining unit 50 read the relationship information, and selects a target device and a standard output specification that are associated with the environment pattern set by the environment identifying unit 44 from the relationship information, to determine the target device and the standard output specification.

In the example of FIG. 10, for the environment pattern PT1 indicating a state of sitting inside a train car, all of the display unit 26A, the sound output unit 26B, and the tactile-stimulus output unit 26C are the target device, and the levels of the standard output specification of those are set to 4. Note that a higher level indicates a higher output stimulus. Moreover, for the environment pattern PT2 indicating a state of walking on a sidewalk, it is an almost safe comfortable situation, but it is considered to be necessary to pay attention to the ahead because it is in a walking state. Therefore, all of the display unit 26A, the sound output unit 26B, and the tactile-stimulus output unit 26C are the target device, and the levels of the standard output specification of those are set to 3. Furthermore, for the environment pattern PT3 indicating a state of walking on a dark street, it cannot be considered as a safe situation, and it is necessary to be in a state of carefully looking ahead, and of being capable of hearing external noise. Therefore, the sound output unit 26B and the tactile-stimulus output unit 26C are the target device, and the levels of the standard output specification of the display unit 26A, the sound output unit 26B, and the tactile-stimulus output unit 26C are set to 0, 2, 2, respectively. Moreover, for the environment pattern PT4 indicating a state of shopping, it is almost safe situation but because it is in a shopping center, so much information that it is distracting is assumed to be unnecessary. Therefore, all of the display unit 26A, the sound output unit 26B, and the tactile-stimulus output unit 26C are the target device, and the levels of the standard output specification of those are set to 2. Note that assignment the target device and the standard output specification for each environment pattern in FIG. 10 is one example, and they may be set as appropriate.

As described, in the present embodiment, the display device 10 sets the target device and the standard output specification based on a relationship among an environment pattern, a target device, and a standard output specification set in advance. However, the setting method of the target device and the standard output specification is not limited thereto, and the display device 10 may set the target device and the standard output specification by any method based on the environment information detected by the environment sensor 20. Moreover, the display device 10 is not limited to select both the target device and the standard output specification based on the environment information, but may select at least one out of the target device and the standard output specification.

Acquisition of Biological Information

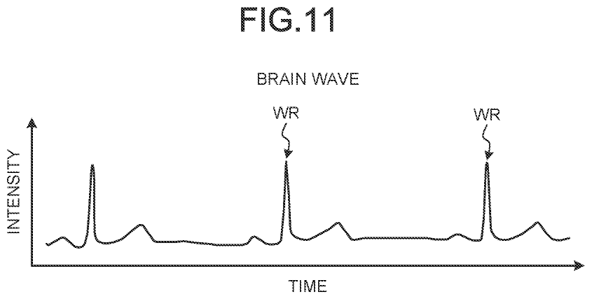

Furthermore, as illustrated in FIG. 4, the display device 10 acquires the biological information of the user U detected by the biological sensor 22 by using the biological-information acquiring unit 42 (step S28). The biological-information acquiring unit 42 acquires pulse wave information of the user U from the pulse wave sensor 22A and acquires brain wave information from the brain wave sensor 22B. FIG. 11 is a graph showing one example of a pulse wave. As illustrated in FIG. 11, the pulse wave has a waveform in which a peak called R-wave WR appears every predetermined time. The heart is controlled by the automatic nervous system, and the pulse rate varies by generating an electrical signal to be a trigger to move the heart at a cellular level. Normally, the pulse rate increases when adrenaline is secreted by stimulation of the sympathetic nerves, and decreases when acetylcholine is secreted by stimulation of the parasympathetic nerves. According to “Evaluation of Diabetic Autonomic Neuropathy by Using Power Spectral Analysis of R-R Intervals in Electrocardiogram” by Nobuyuki Ueda (Diabetes 35(1): 17-23, 1992), functions of the automatic nerves are grasped by analyzing variation of R-R interval in a temporal waveform of a pulse wave as illustrated in the example in FIG. 11. The R-R interval is an interval between chronologically sequent R-waves WR. The electrocardiac signal is repetition of depolarization, action potential and repolarization, resting potential at a cellular level, and by detecting this electrical activity from a body surface, an electrocardiogram can be detected. The propagation speed of pulse waves is very fast, and because it propagates through a body substantially simultaneously with heartbeats, it can be said that heartbeats are synchronized with the pulse wave. Because the pulse wave of heartbeat and the R-wave of the electrocardiogram are synchronized, it can be considered that the R-R interval of the pulse wave is equivalent to the R-R interval in the electrocardiogram. Because variation of the R-R interval of a pulse wave can also be regarded as temporal differential value, by calculating a differential value to detect a magnitude of variation, a degree of activization of the automatic nerve of a living body or a degree of sedation, that is, irritation from a tumult, unpleasantness on a packed train, stress caused in relatively short time, and the like, can be predicted at some level, independently of an intention of a wearer.

On the other hand, as for the brain wave, by detecting waves, such as α wave and β wave, and a basal rhythm (background brain wave) activity that appears in the entire brain, and by detecting its amplitude, increase or decrease of activity as the entire brain can be predicted at some level. For example, from the degree of activity of the prefrontal area of the brain, a degree of attention, such as how much interest is paid on an object by which the sense of sight is stimulated, can be grasped.

Identification of User Condition and Calculation of Output-Specification Correction Level

As illustrated in FIG. 4, having acquired the biological information, the display device 10 identifies a user condition that indicates a mental condition of the user U based on the biological information of the user U, and calculates an output-specification correction level based on the user condition (step S30). The output-specification correction level is a value to correct the standard output specification set by the output-specification determining unit 50, and a final output specification is determined based on the standard output specification and the output-specification correction level.

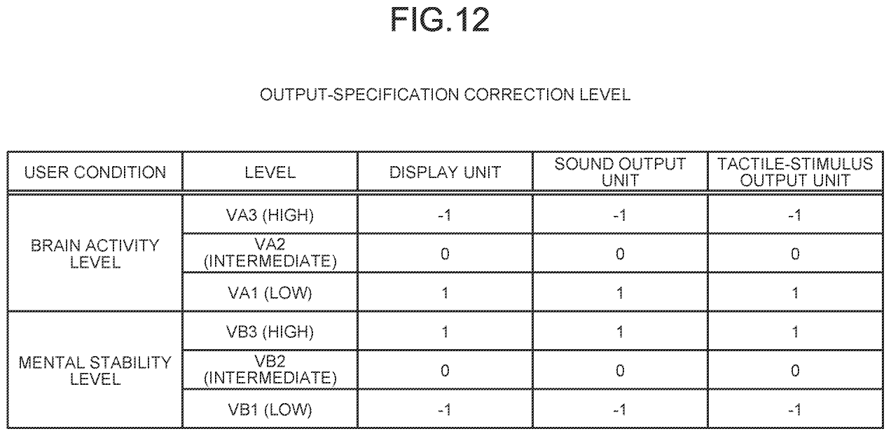

FIG. 12 is a table showing an example of a relationship between the user condition and the output-specification correction level. In the present embodiment, the user-condition identifying unit 46 identifies the degree of brain activity level of the user U as the user condition based on the brain wave information of the user U. The user-condition identifying unit 46 may identify the brain activity level by an arbitrary method based on the brain information of the user U but, for example, may identify the brain activity level from a specific frequency region of a waveform of an α wave and a β wave. In this case, for example, the user-condition identifying unit 46 calculates a power spectrum amount of a high frequency portion (for example, 10 Hz to 11.75 Hz) of an α wave by subjecting a temporal waveform of the brain wave to the fast Fourier transform. When the power spectrum amount of the high frequency portion of an α wave is large, it is estimated as a relaxed but very concentrating state. Therefore, the user-condition identifying unit 46 determines that the brain activity level is higher as the power spectrum amount of the high frequency portion of an α wave is larger. The user-condition identifying unit 46 determines the brain activity level when the power spectrum amount of the high frequency portion of an α wave is within a predetermined numerical value range to VA3, the brain activity level when the power spectrum amount of the high frequency portion of an α wave is within a predetermined numerical value range that is lower than the numerical value range when the brain activity level is VA3 to VA2, and the brain activity level when the power spectrum amount of the high frequency portion of an α wave is within a predetermined numerical value range that is lower than the numerical value range when the brain activity level is VA2 to VA1. It is supposed herein that the brain activity level is higher in order of the brain activity levels VA1, VA2, and VA3. Because a larger power spectrum amount of a high frequency component (for example, 18 Hz to 29.7 Hz) of a β wave indicates a higher possibility of mental “wariness” or “agitation”, the brain activity level may be identified by using the power spectrum amount of a high frequency component of a β wave also.

The user-condition identifying unit 46 determines the output-specification correction level based on the brain activity level of the user U. In the present embodiment, the output-specification correction level is determined based on output-specification correction-level relationship information indicating a relationship with the user condition (the brain activity level in this example) and the output-specification correction level. The output-specification correction-level relationship information is information (table) in which the user condition and the output-specification correction level are stored in an associated manner and, for example, is stored in the specification setting database 30C. In the output-specification correction-level relationship information, the output-specification correction level is set for each type of the output unit 26, that is, the display unit 26A, the sound output unit 26B, and the tactile-stimulus output unit 26C herein. The user-condition identifying unit 46 determines the output-specification correction level based on this output-specification correction-level relationship information and the identified user condition. Specifically, the user-condition identifying unit 46 reads out the output-specification correction-level relationship information, and selects an output-specification correction level that is associated with the set brain activity level of the user U from the output-specification correction-level relationship information, to determine the output-specification correction level. In the example in FIG. 12, for the brain activity level VA3, the output-specification correction levels of the display unit 26A, the sound output unit 26B, and the tactile-stimulus output unit 26C are set respectively to −1, for the brain activity level VA2, the output-specification correction levels of the display unit 26A, the sound output unit 26B, and the tactile-stimulus output unit 26C are set respectively to 0, and for the brain activity level VA1, the output-specification correction levels of the display unit 26A, the sound output unit 26B, and the tactile-stimulus output unit 26C are set respectively to 1. The output-specification correction level is defined to a value that a larger value makes an output specification higher. That is, the user-condition identifying unit 46 sets the output-specification correction level such that the output specification is higher as the brain activity level is lower. To set the output specification high herein means to intensify a sensory stimulus, and it is similarly used in the following also. The values of the output-specification correction level in FIG. 12 are one example, and may be set appropriately.

Moreover, the user-condition identifying unit 46 identifies a mental stability level of the user U as the user condition based on the pulse wave information of the user U. In the present embodiment, the user-condition identifying unit 46 calculates a variation value of interval length between chronologically sequent R-waves WH, that is, a differential value of an R-R interval, and identifies the brain activity level of the user U based on the differential value of the R-R interval. The user-condition identifying unit 46 identifies the mental stability level of the user U as higher, as the differential value of the R-R interval becomes smaller, that is, as the interval length between R-waves WH varies less. In the example in FIG. 12, the user-condition identifying unit 46 categorizes the mental stability level to either one out of three, VB3, VB2, and VB1, from the pulse wave information of the user U. The user-condition identifying unit 46 categorizes a mental stability level when the differential value of the R-R interval is within a predetermined numerical value range to VB3, a mental stability level when the differential value of the R-R interval is within a predetermined numerical value range that is higher than the numerical value range when the mental stability level is VB3 to VB2, and mental stability level when the differential value of the R-R interval is within a predetermined numerical value range that is higher than the numerical value range when the mental stability level is VB2 to VB1. It is supposed that the mental stability level is higher in order of the mental stability levels VB1, VB2, and VB3.

The user-condition identifying unit 46 determines the output-specification correction level based on the output-specification correction-level relationship information and the identified mental stability level. Specifically, the user-condition identifying unit 46 reads out the output-specification correction-level relationship information, and selects an output-specification correction level that is associated with the set mental stability level of the user U from the output-specification correction-level relationship information, to determine the output-specification correction level. In the example in FIG. 12, for the mental stability level VB3, the output-specification correction levels of the display unit 26A, the sound output unit 26B, and the tactile-stimulus output unit 26C are set respectively to 1, for the mental stability level VB2, the output-specification correction levels of the display unit 26A, the sound output unit 26B, and the tactile-stimulus output unit 26C are set respectively to 0, and for the mental stability level VB1, the output-specification correction levels of the display unit 26A, the sound output unit 26B, and the tactile-stimulus output unit 26C are set respectively to −1. That is, the user-condition identifying unit 46 sets the output-specification correction level such that the output specification (sensory stimulus) is higher as the mental stability level becomes higher. The values of the output-specification correction level in FIG. 12 are one example, and may be set appropriately.

As described, the user-condition identifying unit 46 sets the output-specification correction level based on a relationship between the user condition and the output-specification correction level set in advance. However, the method of setting the output-specification correction level is not limited thereto, and the display device 10 may set the output-specification correction level by an arbitrary method based on the biological information detected by the biological sensor 22. Moreover, although the display device 10 calculates the output-specification correction level by using both the brain activity level identified from a brain wave and the mental stability level identified from a pulse wave, it is not limited thereto. For example, the display device 10 may calculate the output-specification correction level by using one out of the brain activity level identified from a brain wave and the mental stability level identified from a pulse wave. Furthermore, the display device 10 expresses the biological information by a numerical value, and by estimating the user condition based on the biological information, it is possible to factor in an error and the like of the biological information, and to estimate a mental condition of the user U more accurately. In other words, it can be said that by classifying the user condition based on the biological information into either one of three or more levels, the display device 10 can estimate a mental condition of the user U accurately. However, the display device 10 is not limited to categorize the biological information and the user condition based on the biological information into three or more levels, but may handle, for example, as information indicating either one of two possible values of Yes and No, and the like.

Generation of Output-Restriction Necessity Information

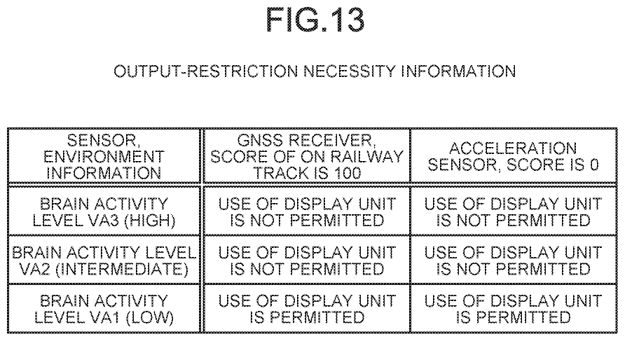

Moreover, as illustrated in FIG. 4, the display device 10 generates output-restriction necessity information based on the biological information of the user U by using the user-condition identifying unit 46 (step S32). FIG. 13 is a table showing an example of the output-restriction necessity information. The output-restriction necessity information is information indicating whether an output restriction of the output unit 26 is necessary, and can be regarded as information that indicates whether to allow activation of the output unit 26. The output-restriction necessity information is generated for each of the output unit 26, that is, the display unit 26A, the sound output unit 26B, and the tactile-stimulus output unit 26C. In other words, the user-condition identifying unit 46 generates the output-restriction necessity information indicating whether to allow activation, for each of the display unit 26A, the sound output unit 26B, and the tactile-stimulus output unit 26C based on the biological information. More specifically, the user-condition identifying unit 46 generates the output-restriction necessity information based on both the biological information and the environment information. The user-condition identifying unit 46 generates the output-restriction necessity information based on the user condition set based on the biological information and the environment score calculated based on the environment information. In the example in FIG. 13, the user-condition identifying unit 46 generates the output-restriction necessity information based on the brain activity level as the user condition, and on the location score for the sub-category of on railway track as the environment score. In the example in FIG. 13, the user-condition identifying unit 46 generates the output-restriction necessity information indicating that use of the display unit 26A is not allowed when the location score for the sub-category of on railway track is 100, and the brain activity level is VA3, VA2. Moreover, in the example in FIG. 13, the user-condition identifying unit 46 generates the output-restriction necessity information based on the brain activity level as the user condition and on the movement score for the sub-category of moving as the environment score. In the example in FIG. 13, the user-condition identifying unit 46 generates the output-restriction necessity information indicating that use of the display unit 26A is not allowed when the movement score for the sub-category of moving is 0, and the brain activity level is VA3, VA2. As described, the user-condition identifying unit 46 generates the output-restriction necessity information indicating that use of the display unit 26A is not allowed when the biological information and the environment information satisfy a specific relationship, in this example, when the user condition and the environment information satisfy a specific relationship. On the other hand, the user-condition identifying unit 46 does not generate the output-restriction necessity information indicating that use of the display unit 26A is not allowed when the user condition and the environment score do not satisfy a specific relationship, and generates the output-restriction necessity information indicating that use of the display unit 26A is allowed. However, generation of the output-restriction necessity information is not essential processing.

Acquisition of Sub-Image

Furthermore, as illustrated in FIG. 4, the display device 10 acquires image data of the sub-image PS by using the sub-image acquiring unit 52 (step S34). The image data of the sub-image PS is image data to display a content (display content) of the sub-image. The sub-image acquiring unit 52 acquires image data of a sub-image from an external device through the sub-image receiving unit 28A.

The sub-image acquiring unit 52 may acquire image data of a sub-image having a content (display content) according to a position (terrestrial coordinates) of the display device 10 (the user U). The position of the display device 10 is identified by the GNSS receiver 20C. For example, when the user U is positioned in a predetermined range with respect to one position, the sub-image acquiring unit 52 receives a content relating to the position. As for the sub-image PS, display control is basically enabled by an intention of the user U, but when display has been enabled, when and in what timing display is shown is unknown and, accordingly, it is convenient but it can be annoying. Therefore, information indicating whether display of the sub-image PS is allowed, a display mode, and the like set by the user U may be stored in the specification setting database 30C. The sub-image acquiring unit 52 reads out this information from the specification setting database 30C, and controls acquisition of the sub-image PS based on this information. Moreover, the position information and the specification setting database 30C may save the same information on a site on the Internet, and the sub-image acquiring unit 52 may control acquisition of the sub-image PS while checking contents thereof. Step S34 at which image data of the sub-image PS is acquired is not limited to be performed before step S36 described later, but may be performed at any time before step S38 described later.

The sub-image acquiring unit 52 may acquire, together with image data of the sub-image PS, sound data and tactile stimulus data relating to the sub-image PS also. The sound output unit 26B outputs sound data relating to the sub-image PIS as a sound content (content of sound), and the tactile-stimulus output unit 26C outputs tactile stimulus data relating to the sub-image PS as a tactile stimulus content (content of tactile stimulus).

Setting of Output Specification

Next, as illustrated in FIG. 4, the display device 10 determines an output specification based on the standard output specification and the output-specification correction level by using the output-specification determining unit 50 (step S36). The output-specification determining unit 50 corrects the standard output specification set based on the environment information by the output-specification correction level set based on the biological information, to determine as a final output specification for the output unit 26. A formula to correct the standard output specification with the output-specification correction level may be arbitrary.

As explained above, the display device 10 corrects the standard output specification set based on the environment information with the output-specification correction level set based on the biological information, to determine a final output specification. However, the display device 10 is not limited to determine an output specification by correcting the standard output specification with the output-specification correction level, but may also determine an output specification by any method using at least one of the environment information and the biological information. That is, the display device 10 may determine an output specification by an arbitrary method based on the environment information and the biological information, or may determine an output specification by an arbitrary method based on either one of the environment information and the biological information.

When the output-restriction necessity information indicating that use of the output unit 26 is not allowed is generated at step S32, the output selecting unit 48 selects a target device not only based on the environment information, but also based on the output-restriction necessity information. That is, even the output unit 26 that has been selected as the target device based on the environment information at step S26 is excluded from the target device when the use is not allowed in the output-restriction necessity information. In other words, the output selecting unit 48 selects a target device based on the output-restriction necessity information and the environment information. Furthermore, because the output-restriction necessity information is set based on the biological information, it can be said that the target device is set based on the biological information and the environment information.

Output Control

Having set the target device and the output specification, and having acquired image data of the sub-image PS and the like, the display device 10 causes the target device to perform output based on the output specification by using the output control unit 54 as illustrated in FIG. 4 (step S38). The output control unit 54 does not activate the output unit 26 that has not been determined as the target device.

For example, the display unit 26A is the target device, the output control unit 54 causes the display unit 26A to display the sub-image PS based on the image data acquired by the sub-image acquiring unit 52, conforming to the output specification of the display unit 26A. More specifically, the output control unit 54 causes the display unit 26A to display the sub-image PS superimposing on the main image PM that is provided through the display unit 26A, and conforming to the output specification of the display unit 26A. Because the output specification is set based on the environment information and the biological information as explained above, by displaying the sub-image PS conforming to the output specification, the sub-image PS can be displayed in an appropriate form according to an environment by which the user U is surrounded and a mental condition of the user U. For example, when display time per unit time of the sub-image PS is set as the output specification, because the display time of the sub-image PS is to be appropriate time according to an environment by which the user U is surrounded and a mental condition of the user U, the sub-image can be provided appropriately to the user U. More specifically, for example, by making the display time of the sub-image PS shorter to reduce a visual stimulus as the brain activity level of the user U is higher or the mental stability level of the user U is lower, it is possible to reduce a possibility of annoying with the sub-image PS when the user U is concentrating on another thing or is not mentally relaxed. On the other hand, when the user U is bored or have mental leeway, by increasing the display time to intensify the visual stimulus, information can be acquired appropriately by the sub-image PS. Furthermore, for example, when the display mode of the sub-image PS (a display position of a sub-image, a size of a sub-image, a modification, and the like) is set as the output specification, because the display mode of the sub-image PS is to be appropriate mode according to an environment by which the user U is surrounded, and a mental condition of the user U, the sub-image can be provided appropriately to the user U. More specifically, by positioning a sub-image on an edge side, by making the size of the sub-image small, or by reducing modifications to reduce the visual stimulus as the brain activity level of the user U is higher or the mental stability level of the user U is lower, and it is possible to reduce a possibility of annoying with the sub-image PS. On the other hand, for example, by positioning a sub-image on a center side, by increasing the size of the sub-image, or by increasing modifications, to intensify the visual stimulus to be stronger as the brain activity of the user U is lower or the mental stability of the user U is higher, information can be thereby acquired appropriately by the sub-image PS.

Moreover, when the sound output unit 26B is the target device, the output control unit 54 causes the sound output unit 26B to output a sound based on sound data that is acquired by the sub-image acquiring unit 52, conforming to the output specification of the sound output unit 26B. In this case also, for example, by reducing the audio stimulus to be weaker as the brain activity level of the user U is higher or the mental stability level of the user U is lower, and it is possible to reduce a possibility of annoying with the sub-image PS when the user U is concentrating on another thing or is not mentally relaxed. On the other hand, by intensifying the audio stimulus to be stronger as the brain activity of the user U is lower or the mental stability of the user U is higher, information can be appropriately acquired by sound.

Furthermore, when the tactile-stimulus output unit 26C is the target device, the output control unit 54 causes the tactile-stimulus output unit 26C to output a tactile stimulus based on tactile stimulus data that is acquired by the sub-image acquiring unit 52, conforming to the output specification of the tactile-stimulus output unit 26C. In this case also, for example, by reducing the tactile stimulus to be weaker as the brain activity level of the user U is higher or the mental stability level of the user U is lower, it is possible to reduce a possibility of annoying with the sub-image PS when the user U is concentrating on another thing or is not mentally relaxed. On the other hand, by intensifying the audio stimulus to be stronger as the brain activity of the user U is lower or the mental stability of the user U is higher, information can be appropriately acquired by a tactile stimulus.

Moreover, when it is determined as a dangerous state and a danger notification content is set at step S12, the output control unit 54 causes the target device to notify of the danger notification content, conforming to the set output specification.

As described, the display device 10 according to the present embodiment can output a sensory stimulus at an appropriate degree according to an environment by which the user U is surrounded or a mental condition of the user U by setting the output specification based on the environment information and the biological information. Furthermore, the display device 10 can select an appropriate sensory stimulus according to an environment by which the user U is surrounded and a mental condition of the user U by selecting the target device to be activated based on the environment information and the biological information. However, the display device 10 is not limited to use both the environment information and the biological information, but may use, for example, only either one. Accordingly, it can be said that the display device 10 is a device that selects the target device and sets the output specification based on the environment information, and a device that selects the target device and sets the output specification based on the biological information also.

Effects

As explained above, the display device 10 according to the present embodiment includes the display unit 26A that displays an image, the biological sensor 22 that detects the biological information of the user U, the output-specification determining unit 50 that determines a display specification (output specification) of the sub-image PS to be displayed on the display unit 26A based on the biological information of the user U, and the output control unit 54 that causes the display unit 26A to display the sub-image PS, superimposing on the main image PM that is provided through the display unit 26A and is visible for the user U, and conforming to the display specification. The display device 10 according to the present embodiment can provide an image appropriately to the user U by superimposing the sub-image PS on the main image PM. Furthermore, by setting the display specification of the sub-image PS to be superimposed on the main image PM based on the biological information, the sub-image PS can be provided appropriately according to a condition of the user U.

Moreover, the biological information includes information relating to the automatic nerve of the user U, and the output-specification determining unit 50 determines the display specification of the sub-image PS based on the information relating to the automatic nerve of the user. The display device 10 according to the present embodiment can provide the sub-image PS appropriately according to a mental condition of the user U by determining the display specification from the biological information relating to the automatic nerve of the user U.

Furthermore, the display device 10 further includes the environment sensor 20 that detects the environment information of the periphery of the display device 10. The output-specification determining unit 50 determines the display specification of the sub-image PS based on the environment information and the biological information of the user U. The display device 10 according to the present embodiment can provide the sub-image PS appropriately according to an environment by which the user is surrounded and a mental condition of the user U by determining the display specification based on the environment information also, in addition to the biological information of the user U.

Moreover, the environment information includes the location information of the user U. The output-specification determining unit 50 determines the display specification of the sub-image PS based on the location information of the user U and the biological information of the user U. The display device 10 according to the present embodiment can provide the sub-image PS appropriately according to a location of the user U and a mental condition of the user U by determining the display specification based on a location of the user U in addition to the biological information of the user U.

Furthermore, the output-specification determining unit 50 categorizes the biological information of the user U to either one out of three or more levels, and determines the display specification of the sub-image PS according to a categorized level. The display device 10 according to the present embodiment grasps a condition of the user U precisely by categorizing the biological information of the user U to three or more levels, to be able to determine the display specification of the sub-image PS based thereon and, therefore, can provide the sub-image PS more appropriately according to a condition of the user U.

Moreover, the output-specification determining unit 50 determines display time of the sub-image PS per unit time as the display specification of the sub-image PS. The display device 10 according to the present embodiment can provide the sub-image PS appropriately according to the condition of the user U by adjusting the display time of the sub-image PS based on the biological information.

Furthermore, the output-specification determining unit 50 determines a display mode indicating how the sub-image PS is to be displayed when it is viewed as a still image as the display specification of the sub-image PS. The display device 10 according to the present embodiment can provide the sub-image PS appropriately according to a condition of the user U by adjusting the display mode of the sub-image PS based on the biological information.

### Second Embodiment

Next, a second embodiment will be explained. The display device 10 according to the second embodiment differs from that of the first embodiment in acquiring advertisement fee information of the sub-image PS also, and in determining the output specification of the sub-image PS based on the advertisement fee information. That is, in the second embodiment, the sub-image PS includes advertisement information. In the second embodiment, for a part having a configuration similar to the first embodiment, explanation will be omitted.

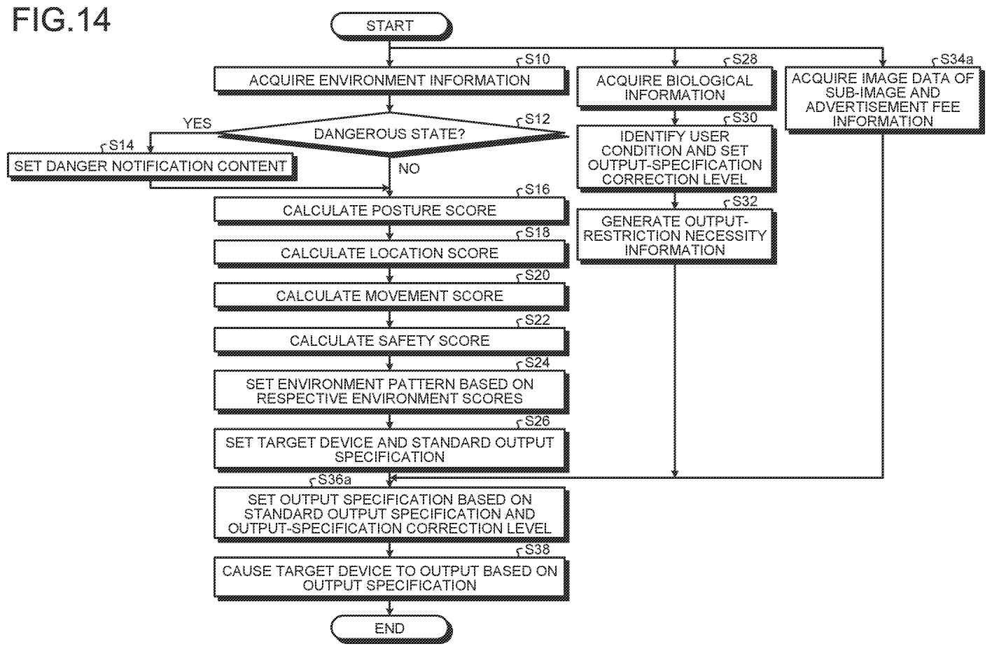

FIG. 14 is a flowchart explaining processing of a display device according to the second embodiment. As illustrated in FIG. 14, because the display device 10 according to the second embodiment performs processing similar to those of the first embodiment from step S10 to step S32, explanation thereof is omitted. On the other hand, the sub-image acquiring unit 52 of the display device 10 according to the second embodiment acquires advertisement fee information of the sub-image PS, in addition to image data of the sub-image PS (step S34a). The advertisement fee information is information relating to an advertisement fee (cost) paid by an advertiser when the sub-image PS, which is an advertisement, is displayed on the display device 10, and can be regarded as information relating to an advertisement fee to be paid to display the advertisement information included in the sub-image PS. Moreover, the advertisement fee information can be regarded as information indicating a degree of cost of advertisement fee, that is, how high the advertisement fee is. The advertisement fee of the sub-image PS is negotiated, for example, between an advertiser and a communication carrier, and the like. The advertisement fee is set for each of the sub-image PS, that is, each single advertisement, and is associated with image data of the sub-image PS. That is, the sub-image acquiring unit 52 according to the second embodiment acquires image data of the sub-image PS, and advertisement fee information associated with the sub-image PS.

The display device 10 according to the second embodiment determines the output specification based on the advertisement fee information also, in addition to the standard output specification and the output-specification correction level (step S36a). That is, in the second embodiment, the output specification is determined based on the standard output specification set from the environment information, the output-specification correction level set from the biological information, and the advertisement fee information.

Specifically, the output-specification determining unit 50 sets an advertisement-fee correction level to correct the standard output specification based on the advertisement fee information. The output-specification determining unit 50 sets the advertisement-fee correction level such that the output specification (sensory stimulus) becomes higher as an advertisement fee is higher in the advertisement fee information. In the example of the present embodiment, the output-specification determining unit 50 determines the advertisement-fee correction level based on advertisement-fee-correction relationship information that indicates a relationship between the advertisement fee information and the advertisement-fee correction level. The advertisement-fee-correction relationship information is information (table) in which advertisement fee information and an advertisement-fee correction level are associated to be stored, for example, in the specification setting database 30C. In the advertisement-fee-correction relationship information, the advertisement-fee correction level is set for each type of the output unit 26, that is, the display unit 26A, the sound output unit 26B, and the tactile-stimulus output unit 26C herein. The output-specification determining unit 50 determines the advertisement-fee correction level based on this advertisement-fee-correction relationship information and the acquired advertisement fee information. Specifically, the user-condition identifying unit 46 reads out the advertisement-fee-correction relationship information, and selects the advertisement-fee correction level that is associated with the acquired advertisement fee information from the advertisement-fee-correction relationship information, to determine the advertisement-fee correction level.

As described, the output-specification determining unit 50 sets the advertisement-fee correction level based on the advertisement-fee-correction relationship information in which the advertisement fee information and the advertisement-fee correction level are associated with each other set in advance. However, the setting method of the advertisement-fee correction level is not limited thereto, and the display device 10 may set the advertisement-fee correction level by an arbitrary method based on the advertisement fee information.

The output-specification determining unit 50 determines the output specification by correcting the standard output specification with the output-specification correction level set based on the biological information and the advertisement-fee correction level set based on the advertisement fee information. A formula to correct the output-specification with the output-specification correction level and the advertisement-fee correction level may be arbitrary. Having thus determined the output specification, the output control unit 54 according to the second embodiment causes the target device to perform output based on the output specification, by a method similar to the first embodiment (step S38).

As described above, the advertisement-fee correction level is set such that the sensory stimulus becomes stronger as an advertisement fee is higher. Therefore, the display time per unit time of the sub-image PS becomes longer as the advertisement fee becomes higher. Moreover, for example, the sub-image PS is displayed at a position closer to the center side as illustrated in FIG. 7, displayed in a larger size as illustrated in FIG. 8, or have more modifications as illustrated in FIG. 9 as the advertisement fee becomes higher.

As explained above, the display device 10 according to the second embodiment determines a final output specification by correcting the standard output specification set based on the environment information with the output-specification correction level set based on the biological information and the advertisement-fee correction level set based on the advertisement fee information. However, the display device 10 according to the second embodiment is not limited to determine an output specification by correcting the standard output specification with the output-specification correction level and the advertisement-fee correction level, but may determine an output specification by an arbitrary method, using at least the advertisement fee information. That is, for example, the display device 10 according to the second embodiment may determine an output specification by an arbitrary method by using all of the advertisement fee information, the environment information, and the biological information, may determine an output specification by an arbitrary method using either one of the environment information and the biological information in addition to the advertisement fee information, or may determine an output specification by an arbitrary method using only the advertisement fee information out of the advertisement fee information, the environment information, and the biological information.

As explained above, the display device 10 according to the second embodiment includes the display unit 26A that displays an image, the sub-image acquiring unit 52, the output-specification determining unit 50, and the output control unit 54. The sub-image acquiring unit 52 of the second embodiment acquires image data of the sub-image PS including advertisement information to be displayed on the display unit 26A, and the advertisement fee information about payment to display the advertisement information. The output-specification determining unit 50 of the second embodiment determines the display mode indicating how the sub-image is displayed when it is viewed as a still image as the output specification (display specification) of the sub-image PS based on the advertisement fee information. The output control unit 54 causes the display unit 26A to display the sub-image PS, superimposing on the main image PM that is visible for the user U, and conforming to the output specification (display specification). Because the display device 10 according to the second embodiment determines the display mode of the sub-image, which is an advertisement, based on the advertisement fee, the sub-image PS can be provided appropriately, properly reflecting an intention of an advertiser.

Moreover, the display device 10 according to the second embodiment includes the display unit 26A that displays an image, the sub-image acquiring unit 52, the output-specification determining unit 50, and the output control unit 54. The sub-image acquiring unit 52 of the second embodiment acquires image data of the sub-image PS including advertisement information to be displayed on the display unit 26A, and the advertisement fee information about payment to display the advertisement information. The output-specification determining unit 50 of the second embodiment determines display time of the sub-image PS per unit time based on the advertisement fee information. The output control unit 54 of the second embodiment causes the display unit 26A to display the sub-image PS, superimposing on the main image PM that is provided through the display unit 26A and is visible for the user U, and conforming to the output specification (display specification). Because the display device 10 according to the second embodiment determines display time of the sub-image PS, which is an advertisement, based on an advertisement fee, the sub-image PS can be provided appropriately, properly reflecting an intention of an advertiser.

### Third Embodiment

Next, a third embodiment will be explained. A display device 10b according to the third embodiment differs from the first embodiment in determining a position at which the sub-image PS is displayed based on permission information indicating whether the sub-image PS can be displayed, superimposing on an actually existing object in the main image PM. In the third embodiment, for a part having a configuration similar to the first embodiment, explanation will be omitted. The third embodiment is applicable to the second embodiment also.

FIG. 15 is a schematic block diagram of a display device according to the third embodiment. As illustrated in FIG. 15, a control unit 32b of the display device 10b according to the third embodiment includes a target-object identifying unit 60 and a permission-information acquiring unit 62. The target-object identifying unit 60 identifies a target object that is an actually existing object shown in the main image PM based on the environment information detected by the environment sensor 20. The permission-information acquiring unit 62 acquires the permission information indicating whether the sub-image PS can be superimposed on an image of the target object identified by the target-object identifying unit 60. The output-specification determining unit 50 according to the third embodiment determines a display position of the sub-image PS based on this permission information, as the output specification. In the following, processing of the display device 10b according to the third embodiment will be specifically explained.

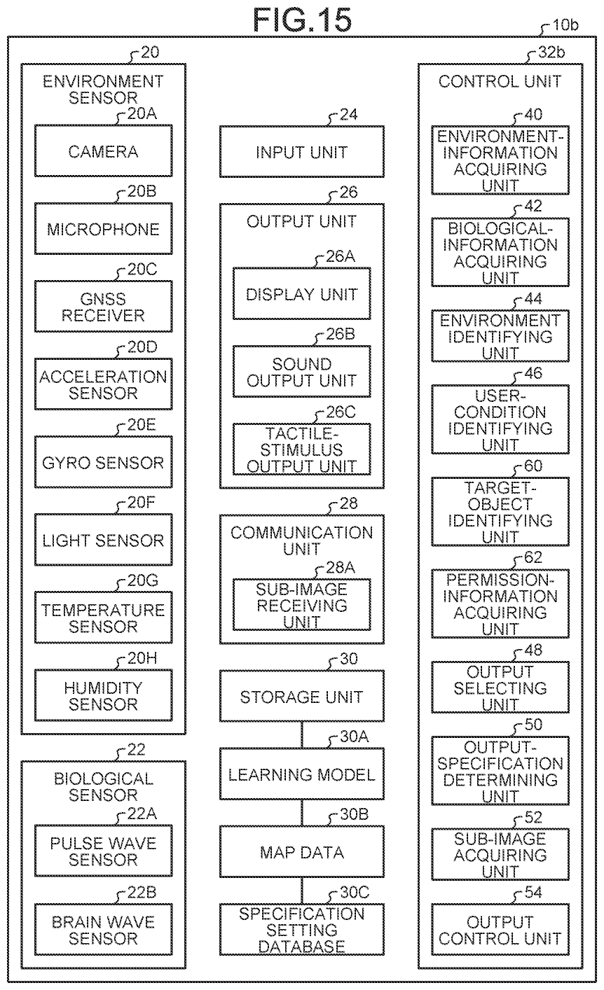

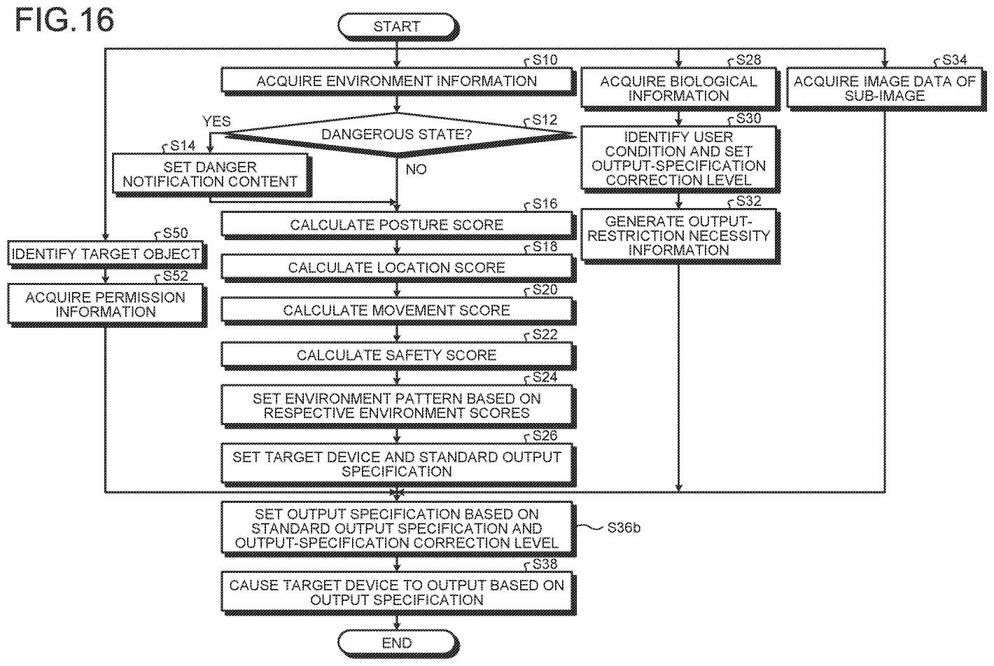

FIG. 16 is a flowchart explaining processing of the display device according to the third embodiment. As illustrated in FIG. 16, the display device 10b according to the third embodiment performs processing similar to that of the first embodiment from step S10 to step S34 and, therefore, explanation thereof will be omitted. On the other hand, the display device 10b according to the third embodiment identifies a target object in the main image PM based on the environment information by the target-object identifying unit 60 (step S50).

Specifically, at step S50, the target-object identifying unit 60 acquires target object information that is information to identify the target object in the main image PM based on the environment information. The target object information may be any information as long as it is information enabling to identify the target object from other objects, and it may be, for example, name of a target object, address of a target object, position information, and the like. The target-object identifying unit 60 acquires the target object information based on the position information of the display device 10b (the user U) acquired by the GNSS receiver 20C and the posture information of the display device 10 (the user U) acquired by the gyro sensor 20E. More specifically, the target-object identifying unit 60 calculates position information of a visually recognized region, which is a place visually recognized by the user U from the position information of the display device 10b (the user U) and the posture information of the display device 10 (the user U). In this case, the target-object identifying unit 60 determines a range that is visually recognized by the user U as a visually-recognized region having a predetermined range of breadth, for example, based on the breadth of vision of the user U, and acquires position information of the visually-recognized region. The breadth of vision of the user U may be set in advance, or may be calculated by an arbitrary method. The target-object identifying unit 60 identifies an actually existing object, such as a structural object and a natural object, present in the visually-recognized region as the target object based on the map data 30B, and acquires the target object information of the target object. That is, because the visually-recognized region signifies a field of view of the user U, and signifies a range of the main image PM, an actually existing object located within the visually-recognized region is to be a target object shown as the main image PM. When plural target objects are present in the visually-recognized region, the target-object identifying unit 60 acquires the target object information for each of those target objects.

The method of identifying a target object by the target-object identifying unit 60, that is, the method of acquiring target object information is not limited to the one described above, and may be arbitrary.

Having identified a target object, the display device 10b according to the third embodiment acquires the permission information for the identified target object by the permission-information acquiring unit 62 (step S52). That is, the permission-information acquiring unit 62 acquires, for the target object identified as present in the main image PM, the permission information indicating whether the sub-image PS can be displayed, superimposed on the target object.

Whether superimposition of the sub-image PS on the target object is permitted is determined in advance by an owner of the target object or the like, and is recorded as the permission information. The permission-information acquiring unit 62 transmits the target object information to an external device (server) in which the permission information is recorded through, for example, the communication unit 28, and acquires the permission information. The external device acquires the permission information assigned to the target object identified in the target object information, to transmit to the display device 10b. The permission-information acquiring unit 62 acquires the permission information assigned to the target object from the external device. The permission-information acquiring unit 62 acquires this permission information for each target object. The method of acquiring the permission information is not limited thereto. For example, information in which the target object information and the permission information are associated with each other may be stored in the storage unit 30 of the display device 10b, and the permission-information acquiring unit 62 may reads out this information to acquire the permission information associated with the acquired target object information.

Thereafter, the display device 10b determines an output specification based on the permission information also, in addition to the standard output specification and the output-specification correction level (step S34). That is, in the third embodiment, the output-specification determining unit 50 determines an output specification based on the standard output specification set from the environment information, the output-specification correction level set from the biological information, and the permission information.

More specifically, the output-specification determining unit 50 determines a display position of the sub-image PS as the output specification based on the permission information. The output-specification determining unit 50 determines whether the sub-image PS may be displayed at the position overlapping a target object based on the permission information. For example, the output-specification determining unit 50 determines not to superimpose the sub-image PS on the target object when the permission information is information indicating that the sub-image PS is not permitted to be displayed on the target object in a superimposed manner, and determines a position other than the position overlapping the target object as the display position of the sub-image PS. That is, the output-specification determining unit 50 excludes a position overlapping the target object from display-enabled positions in which the sub-image PS can be displayed when the permission information is information indicating that the sub-image PS is not permitted to be displayed on the target object in a superimposed manner, and determines a position not overlapping the target object as a display-enabled position of the sub-image PS.

On the other hand, the output-specification determining unit 50 determines that the sub-image PS can be superimposed on the target object when the permission information is information indicating that the sub-image PS can be displayed on the target object in a superimposed manner, and determines a display position of the sub-image PS from among positions overlapping the target object and positions not overlapping the target object. That is, the output-specification determining unit 50 determines both the position overlapping the target object and the position not overlapping the target object as the display-enabled position of the sub-image PS when the permission information is information indicating that the sub-image PS can be displayed on the target object in a superimposed manner.

The output-specification determining unit 50 sets the output specification based on the display-enabled position set based on the permission information, the standard output specification set based on the environment information, and the output-specification correction level set based on the biological information (step S36b). The output-specification determining unit 50 sets the output specification from the standard output specification and the output-specification correction level by a method similar to that of the first embodiment, and sets the display position of the sub-image PS in the output specification based on the display-enabled position. That is, the output-specification determining unit 50 sets the display position of the sub-image PS such that the sub-image PS is displayed in the display-enabled position. For example, the output-specification determining unit 50 determines the display position of the sub-image PS to a position not overlapping the target object when the permission information is information indicating that the sub-image PS is not permitted to be displayed on the target object in a superimposed manner. On the other hand, the output-specification determining unit 50 determines the display position of the sub-image PS to a position overlapping the target object or a position not overlapping the target object when the permission information is information indicating that the sub-image PS is permitted to be displayed on the target object in a superimposed manner. When the permission information is information indicating that the sub-image PS is permitted to be displayed on the target object in a superimposed manner, whether to set the display position of the sub-image PS to the position overlapping the target object may be defined based on the display-enabled position set based on the permission information, the standard output specification set based on the environment information, and the like.

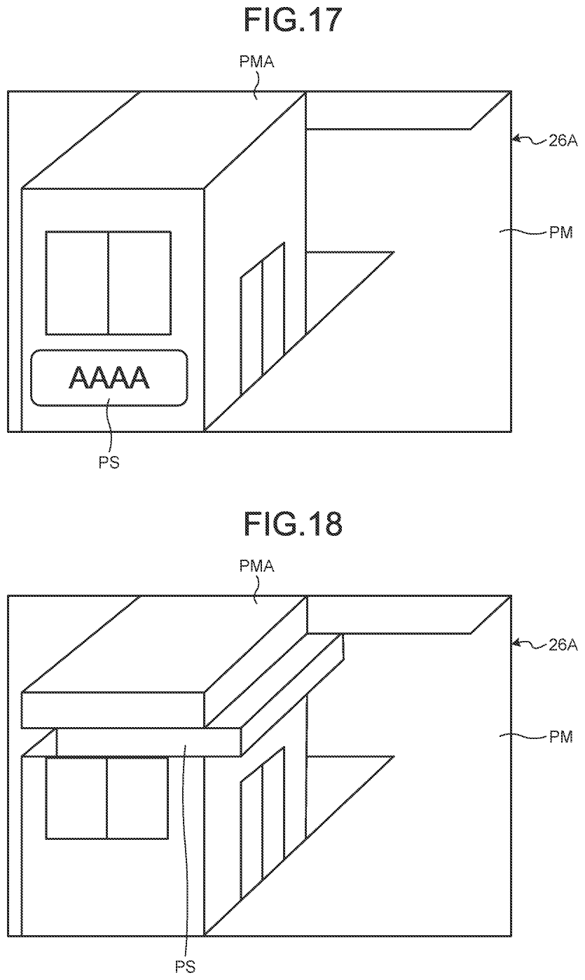

Having set the output specification, the output control unit 54 of the third embodiment causes the target device to perform output based on the output specification by a method similar to that of the first embodiment (step S38). The output control unit 54 controls to display the sub-image PS at a display position based on a determination indicating whether the sub-image PS is permitted to be displayed on the target object in a superimposed manner by the output-specification determining unit 50. That is, the output control unit 54 displays the sub-image PS at a position not overlapping the target object when the permission information is information indicating that the sub-image PS is not permitted to be displayed on the target object in a superimposed manner. On the other hand, the output control unit 54 displays the sub-image PS at a position overlapping or a position not overlapping the target object when the permission information is information indicating that the sub-image PS is permitted to be displayed on the target object in a superimposed manner. FIG. 17 is a diagram illustrating an example of the display image according to the third embodiment. FIG. 17 illustrates one example when the permission information is information indicating that the sub-image PS is permitted to be displayed on a target object PMA in a superimposed manner. As illustrated in FIG. 17, when the permission information is information indicating that the sub-image PS is permitted to be displayed on the target object PMA in a superimposed manner, the output control unit 54 may display the sub-image PS at a position overlapping the target object PMA.

As explained above, the display device 10b according to the third embodiment determines the display position of the sub-image PS based on the standard output specification set based on the environment information, the output-specification correction level set based on the biological information, and the permission information. However, the display device 10b is not limited to determine the display position of the sub-image PS by using the standard output specification, the output-specification correction level, and the permission information. For example, the display device 10 may determine the display position of the sub-image PS using all of the permission information, the environment information, and the biological information by an arbitrary method, may determine the display position of the sub-image PS using either one of the environment information and the biological information, in addition to the permission information by an arbitrary method, or may determine the display position of the sub-image PS using only the permission information out of the permission information, the environment information, and the biological information by an arbitrary method. As described, in the third embodiment, as long as at least the permission information is used to determine the display position of the sub-image PS by an arbitrary method, the environment information and the biological information are not necessarily required to be used.

As explained above, the display device 10b according to the third embodiment includes the display unit 26A that displays an image, the target-object identifying unit 60, the permission-information acquiring unit 62, the output-specification determining unit 50, and the output control unit 54. The target-object identifying unit 60 identifies an actually existing target object in the main image PM that is provided through the display unit 26A and that can be visually recognizable for the user U. The permission-information acquiring unit 62 acquires the permission information indicating whether the sub-image PS may be displayed at a position overlapping the target object of the main image PM. The output-specification determining unit 50 determines whether to display the sub-image PS at a position overlapping the target object of the main image PM based on the permission information. The output control unit 54 controls to display the sub-image PS to be superimposed on the target object of the main image PM based on a determination indicating whether to display the sub-image PS at the position overlapping the target object of the main image PM by the output-specification determining unit 50.

The sub-image PS is displayed in a superimposed manner on the main image PM in which an actually existing object is shown. However, an owner or the like exits for an actually existing object, and it is conceivable that the owner prefers not to have the sub-image PS superimposed on the target object. To deal with this concern, the display device 10b according to the present embodiment determines a display position of the sub-image PS based on the permission information indicating whether the sub-image PS is permitted to overlap the target object. Therefore, it becomes possible to avoid superimposition of the sub-image PS on the target object, for example, when superimposition of the sub-image PS on the target object is not permitted, and to superimpose the sub-image PS on the target object when superimposition of the sub-image PS on the target object is permitted. As described, according to the display device 10b according to the third embodiment by using the permission information, the sub-image PS can be displayed appropriately, for example, considering an intention of the owner of the target object.

Furthermore, in the third embodiment, the target-object identifying unit 60 identifies a target object from the position information of the user U and the posture information of the user. According to the display device 10b according to the third embodiment, by using the position information of the user U and the posture information of the user, a target object in the main image PM can be identified highly accurately.

Another Example of Sub-Image

In the example in FIG. 17, the sub-image PS is superimposed on the target object PMA in the main image PM, and the image of the target object PMA shown as the main image PM has the same shape as the actual shape of the target object PMA. However, the sub-image PS may be displayed such that the image of the target object PMA shown in the main image PM has a shape different from the actual shape of the target object PMA. FIG. 18 is a diagram illustrating an example of the sub-image in which a shape of a target object has a different shape from an actual shape. As illustrated in the example in FIG. 18, the sub-image PS is an image in which a portion of the target object PMA, which is a building, is misaligned, and as it is displayed at a position of the target object PMA in the main image PM, the target object PMA is visually recognized in a different shape from the actual shape of the target object PMA, herein, to have a portion misaligned. That is, the sub-image PS enables the target object to be seen in a shape different from an actual shape by becoming an image that imitates the shape of the target object but has a different shape from the shape of the target object PM.

As described, in the example in FIG. 18, the display device 10b includes the display unit 26A that displays an image, the target-object identifying unit 60, the permission-information acquiring unit 62, the output-specification determining unit 50, and the output control unit 54. The target-object identifying unit 60 identifies an actually existing target object in the main image PM that is provided through the display unit 26A and is visually recognizable for the user U. The permission-information acquiring unit 62 acquires the permission information indicating whether the sub-image PS showing the target object in a different shape from an actual shape can be displayed at a position overlapping the target object of the main image PM. The output-specification determining unit 50 determines whether to display the sub-image PS at a position overlapping the target object of the main image PM based on the permission information. The output control unit 54 controls to display the sub-image PS so as to be superimposed on the main image PM based on a determination indicating whether to display the sub-image PS at the position overlapping the target object in the main image PM by the output-specification determining unit 50. The owner of the target object can prefer not to have the sub-image PS showing the target object in a different shape from the actual shape as described to be displayed. Also for the sub-image PS as described, it is possible to display the sub-image PS appropriately, for example, considering an intention of an owner of a target object or the like by controlling a display position based on the permission information. The sub-image PS that shows a target object in a different shape from the actual target object as illustrated in FIG. 18 is applicable as the sub-image PS of other embodiments.

### Fourth Embodiment

Next, a fourth embodiment will be explained. A display device 10c according to the fourth embodiment differs from the first embodiment in counting the number of times of superimposition of the sub-image PS on a target object. In the fourth embodiment, for a part having a configuration similar to the first embodiment, explanation will be omitted. The fourth embodiment is also applicable to the second embodiment and the third embodiment.

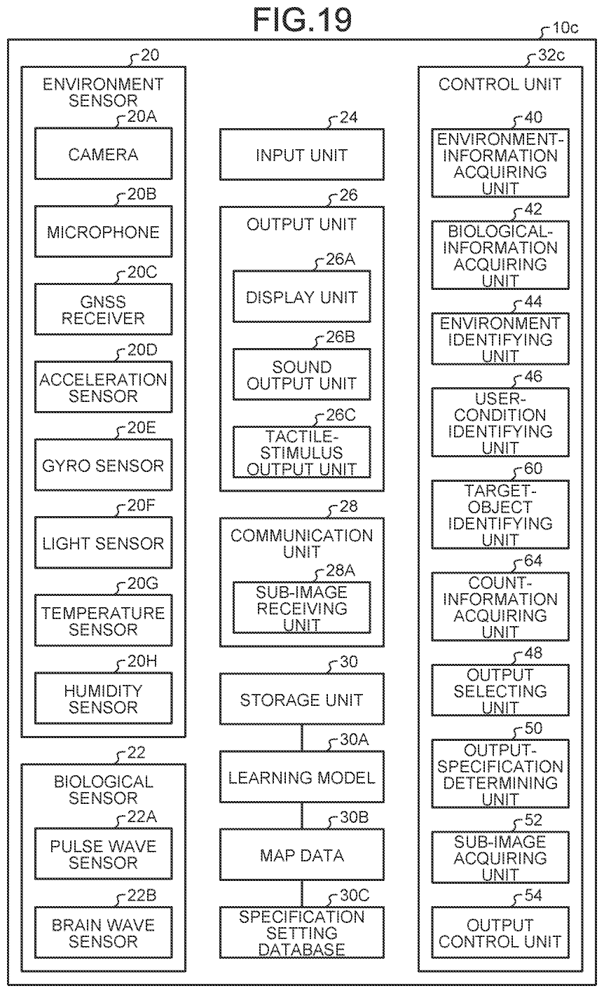

FIG. 19 is a schematic block diagram of a display device according to the fourth embodiment. As illustrated in FIG. 19, a display device 10c according to the fourth embodiment includes the target-object identifying unit 60 and a count-information acquiring unit 64. The target-object identifying unit 60 identifies a target object that is an actually existing object shown in the main image PM based on the environment information detected by the environment sensor 20. The count-information acquiring unit 64 acquires count information that is information about the number of times for which the sub-image PS is superimposed on the target object, to store in the storage unit 30. The count-information acquiring unit 64 records the count information for each target object.

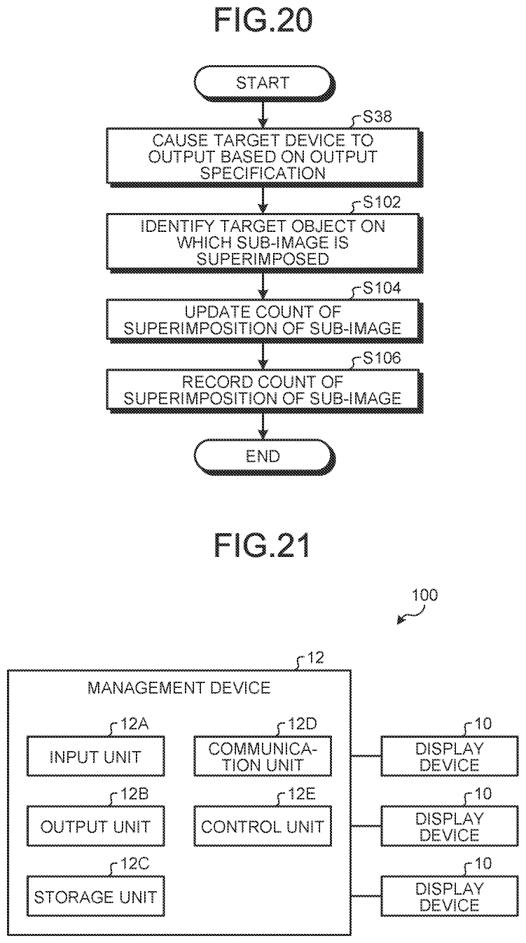

FIG. 20 is a flowchart explaining processing of the display device according to the fourth embodiment. As illustrated in FIG. 20, the display device 10c according to the fourth embodiment causes the target device to output based on the output specification as indicated at step S38. That is, description up to step S38 is omitted in FIG. 20, and in the fourth embodiment also, the processing from step S10 to step S38 (refer to FIG. 4) is performed, to display the sub-image PS to be superimposed on the main image PM.

Next, the display device 10c identifies the target object on which the sub-image PS is superimposed by the target-object identifying unit 60 (step S102). The target-object identifying unit 60 extracts a target object shown in the main image PM by a method similar to that of the third embodiment. The target-object identifying unit 60 then identifies the target object on which the sub-image PS is superimposed from among the target objects shown in the main image PM.

Next, having identified the target object on which the sub-image PS is superimposed, the display device 10c updates the number of times that the sub-image PS is superimposed for each of the target objects by the count-information acquiring unit 64 (step S104), and causes the storage unit 30 to record the number of times that the sub-image PS is superimposed in the storage unit 30 for each of the target objects (step S106). The count-information acquiring unit 64 counts the number of times that the sub-image PS is superimposed for each of the target objects, and stores the number of counts in the storage unit 30 as the count information. That is, the count-information acquiring unit 64 increments the number of times that the sub-image PS is superimposed by 1 each time the sub-image PS is superimposed, and stores it in the storage unit 30 as the count information. The count-information acquiring unit 64 associates the target object information and the count information with each other, that is, associate the number of times that the sub-image PS is superimposed with the target object, to store in the storage unit 30.

As explained above, the display device 10c according to the fourth embodiment includes the display unit 26A that displays an image, the output control unit 54, the target-object identifying unit 60, and the count-information acquiring unit 64. The output control unit 54 displays the sub-image PS so as to be superimposed on an actually existing object included in the main image PM that is provided through the display unit 26A and is visually recognizable for the user U. The target-object identifying unit 60 identifies a target object on which the sub-image PS is superimposed. The count-information acquiring unit 64 acquires the count information that is information about the number of times that the sub-image PS is superimposed on the identified target object, to store in the storage unit 30. The display device 10c according to the present embodiment calculates the number of times that the sub-image PS is superimposed on the target object, to record it. For example, when the sub-image PS is an advertisement, it is conceivable that an advertisement fee is set or an advertisement fee is paid to the owner of the target object on which the sub-image PS is superimposed according to the number of times of display and the like. For example, in such a case, the display device 10c according to the present embodiment can perform management of the advertisement fee and the like appropriately by counting the number of times that the sub-image PS is superimposed for each target object. As described, according to the display device 10c according to the present embodiment, it can be said that by recording the number of times that the sub-image PS is superimposed, the sub-image PS can be displayed appropriately.

The display device 10 can communicate with a management device 12 that manages the count information, and may output the count information to the management device 12. FIG. 21 is a schematic block diagram of a display system according to the fourth embodiment. As illustrated in FIG. 21, a display management system 100 according to the fourth embodiment includes plural units of the display device 10 and the management device 12. The management device 12 is configured to be able to communicate with the display devices 10, and acquires the count information, which is information about the number of times that the sub-image PS is superimposed on a target object, from each of the display devices 10, and records a total value of the number of times of each target object.

The management device 12 is a computer (server) in the present embodiment, and includes an input unit 12A, an output unit 12B, a storage unit 12C, a communication unit 12D, and a control unit 12E. The input unit 12A is a device that accepts an operation of a user of the management device 12, and may be, for example, a touch panel, a keyboard, a mouse, and the like. The output unit 12B is a device that outputs information, and is, for example, a display that displays an image. The storage unit 12C is a memory that stores various kinds of information, such as an arithmetic content of the control unit 12E, a computer program, and the like, and includes, for example, at least one of a main storage device, such as RAM and ROM, and an external storage device, such as HDD. The communication unit 12D is a module that communicates with an external device and the like, and may include, for example, an antenna. A communication method by the communication unit 28 is wireless communication in the present embodiment, but the communication method may be arbitrary.

The control unit 12E is an arithmetic device, that is, a CPU. The control unit 12E performs processing described later by reading and executing a computer program (software) from the storage unit 30, and may perform the processing by a single CPU, or may include plural CPUs and perform the processing by those plural CPUs. Moreover, at least a part of the processing described later performed by the control unit 12E may be implemented by hardware.

The control unit 12E acquires the count information, which is information about the number of times that the sub-image PS is superimposed on a target object, from each of the display devices 10 through the communication unit 12D. The control unit 12E calculates a superimposition total count value that is a total value of the number of times that the sub-image PS is superimposed on the same target object based on the count information acquired from each of the display devices 10. That is, the control unit 12E sums up the number of times that the sub-image PS is superimposed on the same target object for each of the display device 10, and calculates the superimposition total count value. The control unit 12E calculates the superimposition total count value for each target object, and stores it in the storage unit 12C as total count information.

The control unit 12E may output the calculated superimposition total count value to an external device. For example, the control unit 12E may transmit the superimposition total count value to a computer managed by an owner of a target object, or may transmit to a computer managed by an advertiser of the sub-image PS. By thus transmitting the superimposition total count value, management of an advertisement fee can be performed appropriately.

As explained above, the display management system 100 according to the fourth embodiment includes the display device 10 and the management device 12. The management device 12 acquires the count information from plural units of the display device 10, sum up the number of times that the sub-image PS is superimposed on the same target object by the plural display devices 10, and records it as the total count information of the target object. According to the display management system 100 according to the fourth embodiment, by managing the count information of the plural display devices 10c in a centralized manner by the management device 12, display of the sub-image PS can be appropriately managed.

### Fifth Embodiment

Next, a fifth embodiment will be explained. A display device 10d according to the fifth embodiment differs from the first embodiment in selecting a target device and determining an output content (contents) of the sub-image PS based on age information indicating an age of the user U. In the fifth embodiment, for a part having a configuration similar to the first embodiment, explanation will be omitted. The fifth embodiment is also applicable to the second embodiment, the third embodiment, and the fourth embodiment.

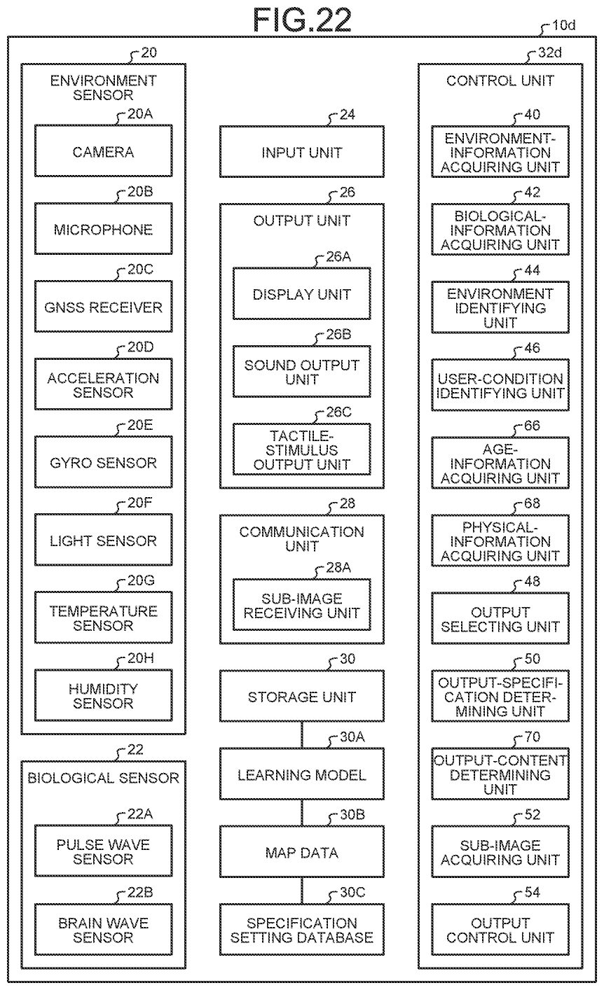

FIG. 22 is a schematic block diagram of a display device according to the fifth embodiment. As illustrated in FIG. 22, a control unit 32d of the display device 10d according to the fifth embodiment includes an age-information acquiring unit 66, a physical-information acquiring unit 68, and an output-content determining unit 70.

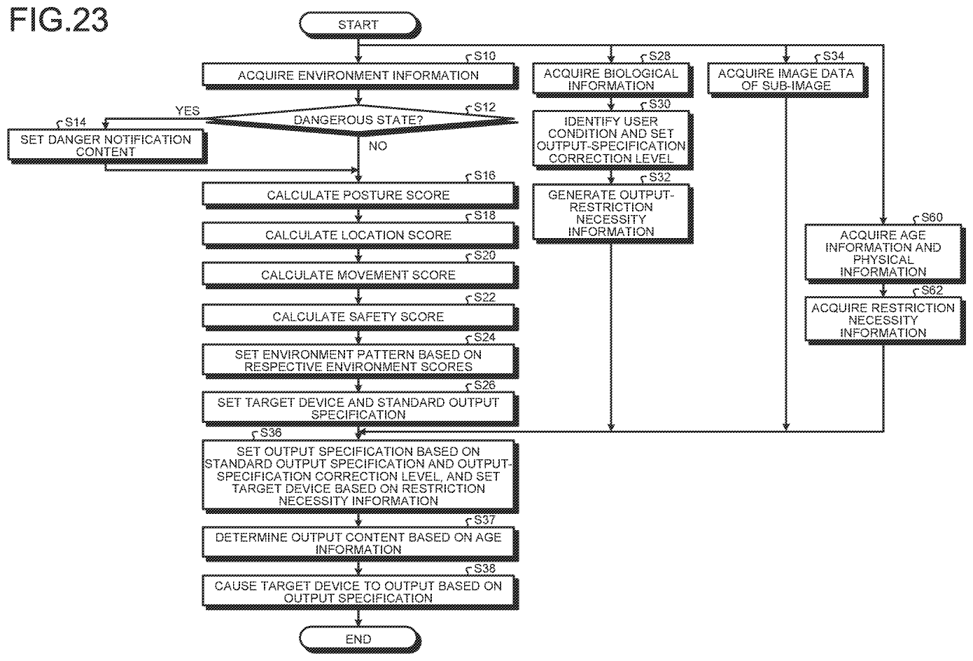

FIG. 23 is a flowchart explaining processing of the display device according to the fifth embodiment. As illustrated in FIG. 23, the display device 10d according to the fifth embodiment performs processing similar to that of the first embodiment from step S10 to step S34 and, therefore, explanation thereof will be omitted. On the other hand, the display device 10d acquires age information of the user U and physical information of the user U by the age-information acquiring unit 66 and the physical-information acquiring unit 68 (step S60).

The age-information acquiring unit 66 acquires age information that indicates an age of the user U. The age-information acquiring unit 66 may acquire the age information by an arbitrary method. For example, the age information may be set in advance in the storage unit 30 by input by the user U and the like, and the age-information acquiring unit 66 may reads out the age information from the storage unit 30. Moreover, for example, the age-information acquiring unit 66 may acquire the age information by estimating an age from the biological information.

The physical-information acquiring unit 68 acquires physical information that is information relating to the body of the user U. The physical information is information that indicates a health condition of the user U, information that is different from the biological information acquired by the biological sensor 22, and information that is different from the information about an automatic nerve. Furthermore, the physical information is information relating to performance of five senses of the user U, and is, for example, information indicating the visual acuity, the auditory acuity, and the like. The physical-information acquiring unit 68 may acquire the physical information by an arbitrary method. For example, the physical information is set in advance by input of the user U or the like to be stored in the storage unit 30, and the physical-information acquiring unit 68 may read out the age information from the storage unit 30. Moreover, for example, a body sensor that detects the physical information of the user U may be equipped in the display device 10, and the physical-information acquiring unit 68 may acquire physical information detected by the body sensor.

Next, the display device 10d acquires restriction necessity information to restrict a control device based on the age information and the physical information by the user-condition identifying unit 46 (step S62). The user-condition identifying unit 46 acquires age-restriction necessity information as the restriction necessity information based on the age information, and acquires physical-restriction necessity information as the restriction necessity information based on the physical information.

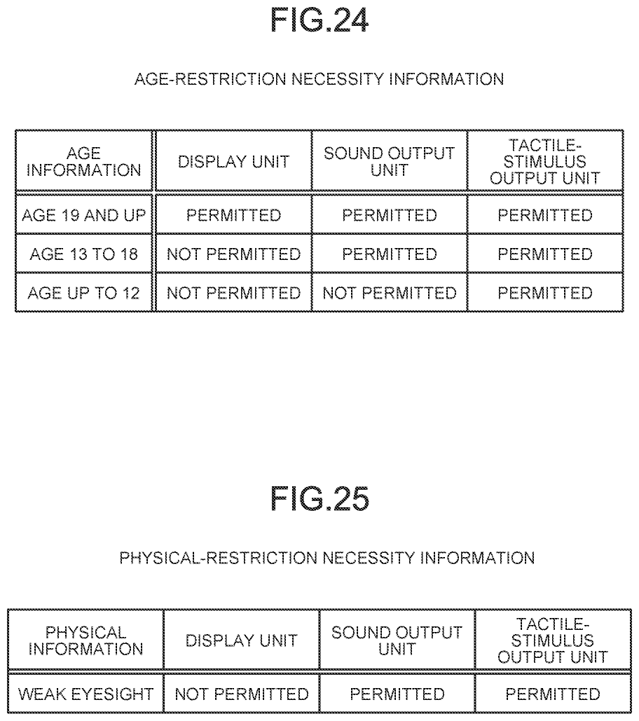

FIG. 24 is a table explaining an example of the age-restriction necessity information. The age-restriction necessity information is information indicating whether output restriction of the output unit 26 is necessary, and can be regarded as information indicating whether the output unit 26 can be selected as the target device. That is, the age-restriction necessity information can be regarded as information to select the target device from the output unit 26. The age-restriction necessity information is set for each of the output unit 26, that is, each of the display unit 26A, the sound output unit 26B, and the tactile-stimulus output unit 26C, and it can be said that the user-condition identifying unit 46 acquires the age-restriction necessity information for each of the display unit 26A, the sound output unit 26B, and the tactile-stimulus output unit 26C based on the age information. More specifically, the user-condition identifying unit 46 acquires the age-restriction necessity information based on age relationship information that indicates a relationship between the age information and the age-restriction necessity information. The age relationship information is information (table) in which the age information and the age-restriction necessity information are stored in an associated manner, and is stored, for example, in the specification-setting database 30C. In the age relationship information, the age-restriction necessity information is set for each predetermined age category for each type of the output unit 26, that is, for each of the display unit 26A, the sound output unit 26B, and the tactile-stimulus output unit 26C in this example. The user-condition identifying unit 46 reads out the age relationship information and selects the age-restriction necessity information that is associated with the age information of the user U from the age relationship information. In the example in FIG. 24, in the age category of ages 19 and up, as the age-restriction necessity information, information indicating that the display unit 26A, the sound output unit 26B, and the tactile-stimulus output unit 26C are respectively permitted to be selected as the target device is assigned. Moreover, in the age category of ages 13 to 18, as the age-restriction necessity information, information indicating that the display unit 26A is not permitted to be selected as the target device, and the sound output unit 26B and the tactile-stimulus output unit 26C are permitted to be selected as the target device is assigned. Furthermore, in the category of ages 12 and under, as the age-restriction necessity information, information indicating that the display unit 26A and the sound output unit 26B are not permitted to be selected as the target device, and the tactile-stimulus output unit 26C is permitted to be selected as the target device is assigned. However, FIG. 24 is one example, and a relationship between the age categories and the age-restriction necessity information in the age relationship information may be set as appropriate.

FIG. 25 is a table explaining an example of the physical-restriction necessity information. The physical-restriction necessity information is information that indicates whether output restriction of the output unit 26 is necessary, and can be regarded as information indicating whether the output unit 26 can be selected as the target device. That is, the physical-restriction necessity information can be regarded as information to select the target device from the output unit 26. The physical-restriction necessity information is set for each of the output unit 26, that is, each of the display unit 26A, the sound output unit 26B, and the tactile-stimulus output unit 26C, and it can be said that the user-condition identifying unit 46 acquires the physical-restriction necessity information for each of the display unit 26A, the sound output unit 26B, and the tactile-stimulus output unit 26C based on the physical information. More specifically, the user-condition identifying unit 46 acquires the physical-restriction necessity information based on physical relationship information that indicates a relationship between the physical information and the physical-restriction necessity information. The physical relationship information is information (table) in which the physical information and the physical-restriction necessity information are stored in an associated manner, and is stored, for example, in the specification-setting database 30C. In the physical relationship information, the physical-restriction necessity information is set for each physical information (physical condition) for each type of the output unit 26, that is, for each of the display unit 26A, the sound output unit 26B, and the tactile-stimulus output unit 26C in this example. The user-condition identifying unit 46 reads out the physical relationship information and selects the physical-restriction necessity information that is associated with the physical information of the user U from the physical relationship information. In the example in FIG. 25, for the physical information indicating that eyesight is weaker than a predetermined threshold, as the physical-restriction necessity information, information indicating that the display unit 26A is not permitted to be selected as the target device, and the sound output unit 26B and the tactile-stimulus output unit 26C are permitted to be selected as the target device is assigned. That is, according to the physical information indicating conditions of five senses of the user U, whether the output unit 26 that stimulates an output to the five senses is used as the target device is set. For example, it can be said that when a sense (for example, vision) of the user U is weaker than a predetermined threshold, it is determined that the output unit 26 (the display unit 26A in this example) stimulating an output to the sense (vision in this example) is excluded from the target device. However, FIG. 25 is one example, and the relationship between the physical information and the physical-restriction necessity information in the physical relationship information may be set as appropriate.

Next, as illustrated in FIG. 23, the display device 10d determines an output specification based on the standard output specification and the output-specification correction level by the output-specification determining unit 50, and determines a target device based on the restriction necessity information by the output selecting unit 48 (step S36d). The output-specification determining unit 50 determines the output specification by a method similar to that of the first embodiment. On the other hand, in the fifth embodiment, the output selecting unit 48 selects a target device abased on the age-restriction necessity information and the physical-restriction necessity information. More specifically, the output selecting unit 48 excludes even an output unit that has been selected as the target device based on the environment score at step S26 from the target device when use thereof is not permitted in the age-restriction necessity information or the physical-restriction necessity information. Moreover, the output selecting unit 48 sets the target device based also on the output-restriction necessity information set based on the biological information at step S32. Therefore, it is regarded that the output selecting unit 48 sets the target device based on the age information, the physical information, the biological information, and the environment information.

As described, the output selecting unit 48 sets the target device based on the age-restriction necessity information based on the age information, the physical-restriction necessity information based on the physical information, the output-restriction necessity information based on the biological information, and the user condition based on the environment information. However, the setting method of the target device is not limited thereto, but may be arbitrary. The output selecting unit 48 may set the target device by an arbitrary method based on at least one of the age information, the physical information, the biological information, and the environment information. For example, the output selecting unit 48 may set the target device by an arbitrary method based on the age information, may set the target device by an arbitrary method based on the age information and the physical information, may set the target device by an arbitrary method based on the age information, the physical information, and the biological information, may set the target device by an arbitrary method based on the age information, the physical information, and the environment information, and may set the target device by an arbitrary method based on the age information, the physical information, the biological information, and the environment information.

Next, as illustrated in FIG. 23, the display device 10d determines an output content (display content) of the sub-image PS output by the output unit 26 based on the age information, by the output-content determining unit 70 (step S37). The output content (display content) of the sub-image PS is a content of the sub-image PS, that is, contents. Step S37 to determine the output content is not limited to be performed after step S36, and performing order is arbitrary.

To the sub-image PS, a content rating that is information indicating whether the content of the sub-image PS is permitted to be provided is set. This content rating is set for each predetermined age categories. That is, the content rating can be regarded as information defining a recommended age to which the content can be provided. Examples of the content rating include a motion picture association of America (MPAA) rating, but it is not limited thereto. In the fifth embodiment, the sub-image acquiring unit 52 acquires the content rating of the sub-image PS together with image data of the sub-image PS. The output-content determining unit 70 determines whether the sub-image PS can be displayed based on the content rating of the sub-image PS and the age information of the user U. The output-content determining unit 70 determines that display of the sub-image PS is possible when the content rating of the sub-image PS indicates that the sub-image PS can be provided to the age of the user U, and determines the content of the sub-image PS as the output content. On the other hand, the output-content determining unit 70 determines not to permit display of the sub-image PS when the content rating of the sub-image PS indicates that the sub-image PS cannot be provided to the age of the user U, and avoids using the content of the sub-image PS as the output content. For example, in this case, the output-content determining unit 70 acquires the content rating of another sub-image PS acquired by the sub-image acquiring unit 52, and similarly determines whether display of the sub-image PS is possible.

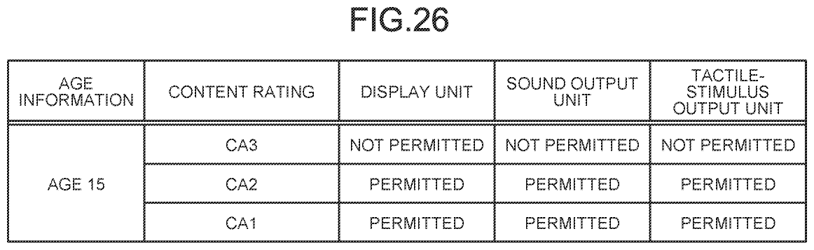

FIG. 26 is a table showing an example of the content rating. In the example in FIG. 26, a content rating CA3 sets, for example, a recommended age to which a content can be provided is age of 19 and up, a content rating CA2 sets, for example, a recommended age to which a content can be provided is age of 13 and up, and a content rating CA1 sets, for example, a recommended age to which a content can be provided has no restriction, that is, can be provided to all ages. For example, when the age information indicates age 15, the output-content determining unit 70 does not permit provision of the sub-image PS of the content rating CA3, and permits provision of the sub-images PS of the content ratings CA2, CA1. In FIG. 26, the output-content determining unit 70 determines to permit or not permit collectively for all of the output unit 26, that is, the display unit 26A, the sound output unit 26B, and the tactile-stimulus output unit 26C. However, it is not limited to manage all of the output unit 26 collectively, but the output-content determining unit 70 may determine output of a content of the sub-image PS for each of the output unit 26, that is, for each of the display unit 26A, the sound output unit 26B, and the tactile-stimulus output unit 26C based on the content rating and the age information. As described, by determining whether output of a content is necessary for each of the output unit 26, it is possible to flexibly deal with various situations, for example, when an image is inappropriate but a sound and a tactile stimulus are appropriate, or the like.

As described, the output-content determining unit 70 determines an output content of the sub-image PS based on the age information and the content rating, but a determining method of an output content of the sub-image PS is not limited to the one described above, but arbitrary. The output-content determining unit 70 may determine an output content of the sub-image PS by an arbitrary method based on the age information.

Returning back to FIG. 23, having determined an output content, the display device 10d causes the target device to output the determined content based on the output specification (step S38). That is, the display device 10d causes it to display the sub-image PS of the determined output content (contents), superimposed on the main image PM, and conforming to the determined output specification.

As explained above, the display device 10d according to the fifth embodiment includes the display unit 26A that displays an image, the sound output unit 26B that outputs a sound, the tactile-stimulus output unit 26C that outputs a tactile stimulus to the user U, the age-information acquiring unit 66, the output selecting unit 48, and the output control unit 54. The age-information acquiring unit 66 acquires the age information of the user U. The output selecting unit 48 selects the target device to be used from among the display unit 26A, the sound output unit 26B, and the tactile-stimulus output unit 26C based on the age information of the user U. The output control unit 54 controls the selected target device. Because of a reason that the ability of the five sense of humans change according to ages, which sense is preferable to be stimulated can vary according to ages. To deal with this, the display device 10d according to the present embodiment selects the target device to be used from among the display unit 26A, the sound output unit 26B, and the tactile-stimulus output unit 26C according to the age of the user U. Therefore, according to the display device 10d, appropriate stimulation of a sense of the user U according to the physical condition of the user U is possible and, for example, the sub-image PS can be provided to the user U appropriately.

Moreover, the display device 10d further includes the physical-information acquiring unit 68 that acquires the physical information of the user U, and the output selecting unit 48, and selects the target device to be used from among the display unit 26A, the sound output unit 26B, and the tactile-stimulus output unit 26C based also on the physical information. Because the display device 10d according to the present embodiment selects the target device to be used from among the display unit 26A, the sound output unit 26B, and the tactile-stimulus output unit 26C according to the physical information of the user U, it is possible to stimulates a sense of the user U appropriately according to the physical condition of the user U and, for example, the sub-image PS can be provided to the user U appropriately also.

### Sixth Embodiment

Next, a sixth embodiment will be explained. A display device 10e according to the sixth embodiment differs from the first embodiment in determining an output content (contents) of the sub-image PS based on the age information of the user U and the position information of the user U. In the sixth embodiment, for a part having a configuration similar to the first embodiment, explanation will be omitted. The sixth embodiment is also applicable to the second embodiment, the third embodiment, the fourth embodiment, and the fifth embodiment.

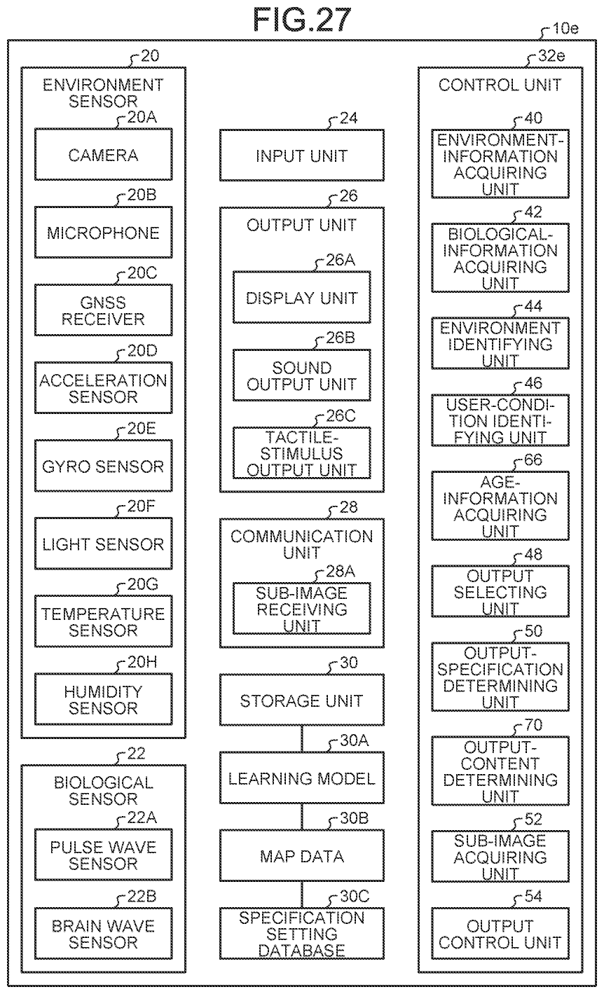

FIG. 27 is a schematic block diagram of a display device according to the sixth embodiment. As illustrated in FIG. 27, a control unit 32e of the display device 10e according to the sixth embodiment includes the age-information acquiring unit 66 and the output-content determining unit 70.

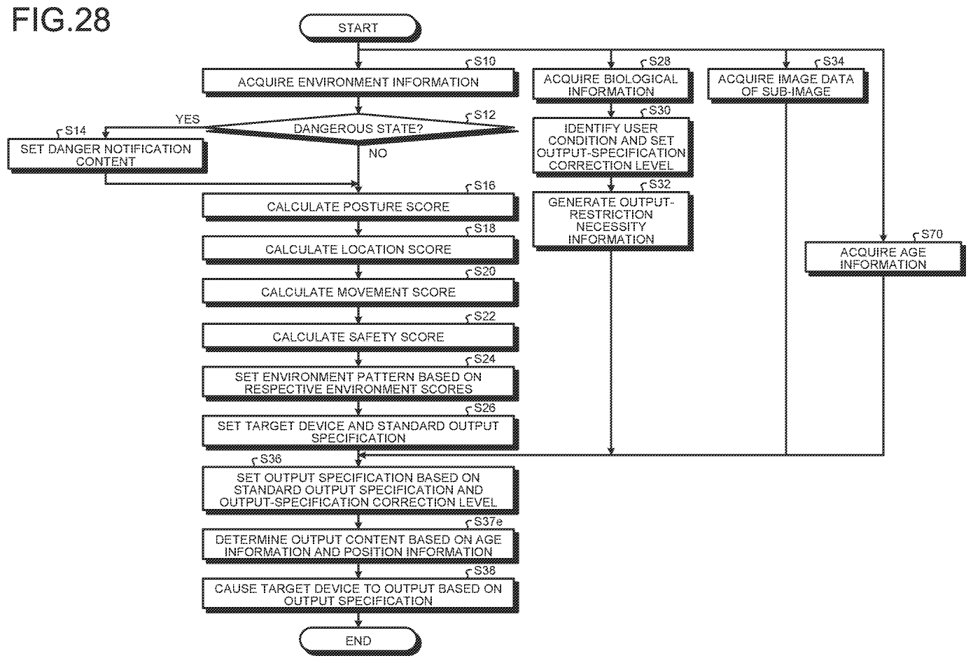

FIG. 28 is a flowchart explaining processing of the display device according to the sixth embodiment. As illustrated in FIG. 28, because the display device 10e according to the sixth embodiment performs processing similar to that of the first embodiment from step S10 to step S36, explanation thereof will be omitted. On the other hand, the display device 10e acquires the age information of the user U by the age-information acquiring unit 66 (step S70).

The age-information acquiring unit 66 acquires the age information indicating the age of the user U. The age-information acquiring unit 66 may acquire the age information by an arbitrary method. For example, the age information set in advance by input of the user U may be stored in the storage unit 30, and the age-information acquiring unit 66 may read out the age information from the storage unit 30. Moreover, for example, the age-information acquiring unit 66 may acquire the age information by estimating an age from the biological information.

Having acquired the age information, the display device 10e determines an output content (display content) of the sub-image PS output by the output unit 26 based on the age information and the position information, by the output-content determining unit (step S37e). The age information of the user U is acquired by the age-information acquiring unit 66 as described above, and the position information of the user U is acquired by the environment-information acquiring unit 40 through the GNSS receiver 20C. The output content (display content) of the sub-image PS is a content of the sub-image PS, that is, contents. Step S37e to determine the output content is not limited to be performed after step S36, but performing order is arbitrary.

To the sub-image PS, similarly to the fifth embodiment, the content rating indicating whether a content can be provided according to ages is set, and the sub-image acquiring unit 52 acquires the content rating of the sub-image PS also together with image data of the sub-image PS. Furthermore, in the sixth embodiment, an area rating indicating whether provision of a content is necessary according to a position (terrestrial coordinates) is set. The output-content determining unit 70 sets a final rating that indicates final determination whether a content can be provided to the user U based on the content rating and the area rating, and determines an output content of the sub-image PS based on the final rating and the age information of the user U. In the following, it will be specifically explained.

The output-content determining unit 70 acquires area information that indicates a relationship between the area rating and a position (terrestrial coordinates). In the area rating information, an area rating is set for each position. For example, for a predetermined range, such as 50-meter radius from a position at which an elementary school or the like is present, the area rating is set such that contents that can be provided is strictly restricted, that is, contents that can be provided is a few. Moreover, for example, for an area in a downtown, the area rating is set such that restriction of contents that can be provided is eased, that is, contents that can be provided is not to be a few. Moreover, for other areas, the area rating is set such that the restriction of contents that can be provided is intermediate. The output-content determining unit 70 may acquire the area rating information by an arbitrary method and, for example, the area rating information may be included in the map data 30B, and the output-content determining unit 70 may acquire the area rating information by reading the map data 30B.

The output-content determining unit 70 sets the area rating to be applied based on the position information of the user U and the area rating information acquired. The output-content determining unit 70 applies the area rating that is associated with the acquired position information of the user U in the area rating information.

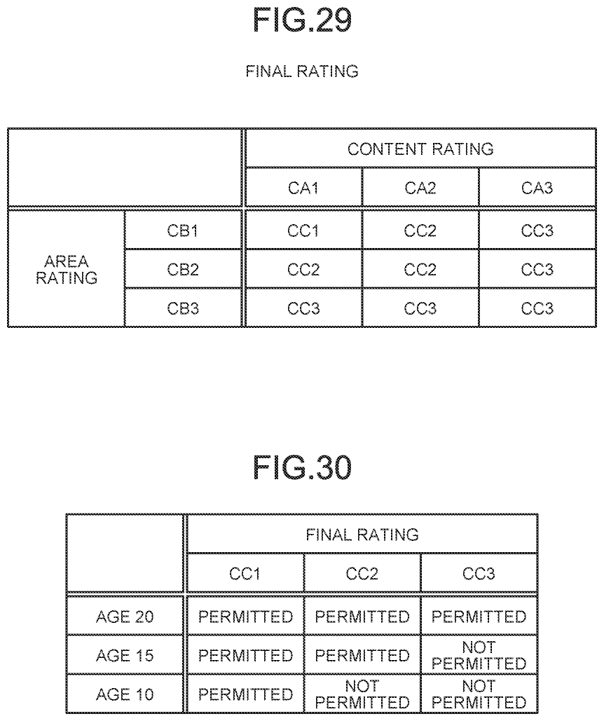

FIG. 29 is a table showing an example of the final rating. The output-content determining unit 70 sets the final rating of the sub-image PS based on the acquired content rating of the sub-image PS and the area rating set based on the position information of the user U. The output-content determining unit 70 sets one for which the restriction of contents that can be provided is strict out of the content rating of the sub-image PS and the area rating as the final rating. In the example in FIG. 29, final ratings for respective combinations of the content ratings CA1, CA2, CA3, and the area ratings CB1, CB2, and CB3. In the example in FIG. 29, for the content rating CA3, the restriction of contents that can be provided is strict, and the recommended age to which the content can be provided is, for example, age of 19 and up, for the content rating CA2, the restriction of contents that can be provided is less strict than the content rating CA3, and the recommended age to which the content can be provided is, for example, age of 13 and up, and for the content rating CA1, the restriction of contents that can be provided is less strict than the content rating CA2, and the recommended age to which the content can be provided has, for example, no restrictions, that is, can be provided to all ages. Furthermore, in the example in FIG. 29, for the area rating CB3, the restriction of contents that can be provided is strict, and the recommended age to which the content can be provided is, for example, age of 19 and up, for the area rating CB2, the restriction of contents that can be provided is less strict than the area rating CB3, and the recommended age to which the content can be provided is, for example, age of 13 and up, and for the area rating CB1, the restriction of contents that can be provided is less strict than the area rating CB2, and the recommended age to which the content can be provided has, for example, no restrictions, that is, can be provided to all ages. Moreover, for the final rating CC3, the restriction of contents that can be provided is strict, and the recommended age to which the content can be provided is, for example, age of 19 and up, for the final rating CC2, the restriction of contents that can be provided is less strict than the final rating CC3, and the recommended age to which the content can be provided is, for example, age of 13 and up, and for the final rating CC1, the restriction of contents that can be provided is less strict than the final rating CC2, and the recommended age to which the content can be provided has, for example, no restrictions, that is, can be provided to all ages.

Hereinafter, for convenience of explanation, a combination of the content rating CA1 and the area rating CB1 is denoted as combination CA1-CB1, and others are also similarly denoted. As described above, out of the content rating and the area rating, one having the restriction of contents that can be provided is strict is set as the final rating. Therefore, in the example in FIG. 29, for the combination CA-CB1, the final rating is CC1, for the combination CA1-CB2, CA2-CB1, CA2-CB3, the final rating is CC2, and for the combination CA1-CB3, CA2-CB3, CA3-CB1, CA3-CB2, CA3-CB3, the final rating is CC3.

Having set the final rating, the output-content determining unit 70 determines an output content of the sub-image PS based on the final rating and the age information of the user U. The output-content determining unit 70 determines whether the sub-image PS can be displayed based on the final rating and the age information of the user U. The output-content determining unit 70 determines that display of the sub-image PS is possible when the content is permitted to be provided to the age of the user U in the final rating, and determines the content of the sub-image PS as the output content. On the other hand, the output-content determining unit 70 determines that display of the sub-image PS is not permitted when the content is not permitted to be provided to the age of the user in the final rating, and does not use the content of the sub-image PS as the output content. For example, in this case, the output-content determining unit 70 acquires the final rating for another piece of the sub-image PS acquired by the sub-image acquiring unit 52, and similarly determines whether display of the sub-image PS is possible.

FIG. 30 is a table explaining an example of determination of an output content based on the final rating. As illustrated in FIG. 30, for example, in the case of the final rating being CC1, display of the sub-image PS is permitted when the age of the user U is either of 10, 15, and 20, in the case of the final rating being CC2, display of the sub-image PS is not permitted when the age of the user U is 10, and in the case of the final rating being CC3, display of the sub-image PS is not permitted when the age of the user U is 10 and 15.

Returning back to FIG. 28, having determined the output content, the display device 10e causes the target device to output the determined output content based on the output specification (step S38). That is, the display device 10d superimposes the determined output content (contents) of the sub-image PS on the main image PM, to be displayed, conforming to the determined output specification.

As described, the output-content determining unit 70 determines the output content of the sub-image PS based on the final rating set from the content rating and the area rating, and the age information, but the determining method of the output content of the sub-image PS is not limited to the one described above, and is arbitrary. The output-content determining unit 70 may determine the output content by an arbitrary method based on the age information of the user U and the age information. Moreover, the output-content determining unit 70 is not limited to use both the age information of the user U and the age information, but may determine the output content by an arbitrary method based on the age information of the user U.

As explained above, the display device 10e according to the sixth embodiment includes the display unit 26A that displays an image, the age-information acquiring unit 66, the output-content determining unit 70, and the output control unit 54. The age-information acquiring unit 66 acquires the age information of the user U. The output-content determining unit 70 determines a display content (output content) of the sub-image PS to be displayed on the display unit 26A based on the age information of the user U. The output control unit 54 controls the display unit 26A to display the determined display content of the sub-image PS in a superimposed manner on the main image PM that is provided through the display unit 26A and is visually recognizable for the user U. The content of the sub-image PS can include an inappropriate content depending on the age of the user U. To deal with this concern, the display device 10e according to the present embodiment determines a content of the sub-image PS according to the age of the user U and, therefore, the sub-image PS can be provided appropriately according to the age.

Moreover, the display device 10e further includes the environment sensor 20 that detects position information of the user U, and the output-content determining unit 70 determines a display content of the sub-image PS based on the position information of the user U also. The content of the sub-image PS can be inappropriate to be provided depending on an area, such as neighborhood of an elementary school. To deal with this, the display device 10e according to the present embodiment determines a content of the sub-image PS according to the position information of the user U in addition to the age of the user U and, therefore, the sub-image PS can be provided appropriately according to the age of the user U and the area.

Furthermore, the output-content determining unit 70 acquires the area rating information that indicates a relationship between terrestrial coordinates and a display content permitted to be displayed (that is the area rating) set in advance, and determines a display content of the sub-image PS based on the area rating information and the position information of the user U. The display device 10e according to the present embodiment sets the area rating to restrict provision of the sub-image PS to be applied at a current position of the user U from the area rating information and the position information of the user U, and determines a display content of the sub-image PS based on the area rating. Therefore, the display device 10e according to the present embodiment can provide the sub-image PS appropriately according to the age of the user U and the area.

The computer program for performing the display method described above may be provided by being stored in a non-transitory computer-readable storage medium, or may be provided via a network such as the Internet. Examples of the computer-readable storage medium include optical discs such as a digital versatile disc (DVD) and a compact disc (CD), and other types of storage devices such as a hard disk and a semiconductor memory.

According to the present embodiment, an image can be appropriately provided to a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display device comprising:
a display unit configured to display an image;
a biological sensor configured to detect biological information of a user;
an output-specification determining unit configured to determine a display specification of a sub-image to be displayed on the display unit based on the biological information of the user;
an output control unit configured to cause the display unit to display the sub-image in a superimposed manner on a main image that is visually recognized through the display unit and based on the display specification; and
an environment sensor configured to detect environment information of a periphery of the display device, wherein
the environment information includes location information of the user,
the biological information includes brain wave information of the user, and
the output-specification determining unit is configured to determine display time of the sub-image per unit time as the display specification of the sub-image based on the location information of the user and the brain wave information of the user.

2. The display device according to claim 1, further comprising:
a sound output unit configured to output a sound;
a tactile-stimulus output unit configured to output a tactile stimulus to the user;
a user-condition identifying unit configured to calculate an output-specification correction level based on the brain wave information of the user, the output-specification correction level being used to correct a standard output specification for adjusting outputs of the display unit, the sound output unit, and the tactile-stimulus output unit, wherein
the output-specification determining unit is configured to determine the standard output specification based on the location information of the user, and correct the standard output specification by using the output-specification correction level to calculate the outputs for the display unit, the sound output unit, and the tactile-stimulus output unit.

3. The display device according to claim 1, wherein
the biological information includes information relating to an automatic nerve of the user, and
the output-specification determining unit is configured to determine the display specification of the sub-image based on information relating to automatic nerve of the user.

4. The display device according to claim 1, wherein
the output-specification determining unit is configured to categorize the biological information of the user to either one out of three or more levels, and determine the display specification of the sub-image based on the categorized level.

5. The display device according to claim 1, wherein
the output-specification determining unit is configured to determine a display mode in which the sub-image is displayed as the display specification of the sub-image.

6. The display device according to claim 1, further comprising:
a target-object identifying unit configured to identify a target object in the main image visually recognized through the display unit; and
a permission-information acquiring unit configured to acquire permission information indicating whether the sub-image is to be displayed at a position overlapping the target object in the main image, wherein
the output-specification determining unit is configured to determine whether to display the sub-image at the position overlapping the target object in the main image based on the permission information, and
the output control unit is configured to cause the display unit to display the sub-image in a superimposed manner on the main image based on determination of the output-specification determining unit.

7. The display device according to claim 1, further comprising:
a target-object identifying unit configured to identify a target object included in the main image visually recognized through the display unit; and
a permission-information acquiring unit configured to acquire permission information indicating whether the sub-image showing the target object in a different shape from an actual shape is to be displayed at a position overlapping the target object in the main image, wherein
the output-specification determining unit is configured to determine whether to display the sub-image at the position overlapping the target object in the main image based on the permission information.

8. The display device according to claim 1, wherein
the output control unit is configured to cause the display unit to display the sub-image in a superimposed manner on a target object included in the main image visually recognized through the display unit, and
the display device further comprises:
a target-object identifying unit configured to identify the target object included in the main image on which the subject-image is superimposed; and
a count-information acquiring unit configured to acquire count information being information about number of times for which the sub-image is displayed superimposed on the identified target object, to store in a storage unit.

9. The display device according to claim 1, further comprising:
an age-information acquiring unit configured to acquire age information of the user; and
an output-content determining unit configured to determine a display content of the sub-image to be displayed on the display unit based on the age information of the user, wherein
the output control unit is configured to cause the display unit to display the sub-image having the determined display content in a superimposed manner on the main image visually recognized through the display unit.

10. The display device according to claim 1, further comprising
a sub-image acquiring unit configured to acquire image data of the sub-image including advertisement information to be displayed on the display unit, and advertisement fee information about payment to display the advertisement information, wherein
the output-specification determining unit is configured to determine a display mode in which the sub-image is displayed based on the advertisement fee information, as the display specification of the sub-image, and
the output control unit is configured to cause the display unit to display the sub-image in a superimposed manner on the main image visually recognized through the display unit, and based on the display specification.

11. The display device according to claim 1, further comprising
a sub-image acquiring unit configured to acquire image data of the sub-image including advertisement information to be displayed on the display unit, and advertisement fee information about payment to display the advertisement information, wherein
the output-specification determining unit is configured to determine display time of the sub-image per unit time as the display specification of the sub-image based on the advertisement fee information, and
the output control unit is configured to cause the display unit to display the sub-image in a superimposed manner on the main image visually recognized through the display unit and based on the display specification.

12. The display device according to claim 2, further comprising:
an age-information acquiring unit configured to acquire age information of the user; and
an output selecting unit configured to select as a target device to be used one of the display unit, the sound output unit, and the tactile-stimulus output unit based on the age information of the user, wherein
the output control unit is configured to control the target device.

13. A display method comprising:
detecting biological information of a user;
determining a display specification of a sub-image to be displayed on a display unit based on the biological information of the user;
detecting environment information of a periphery of the display unit; and
causing the display unit to display the sub-image in a superimposed manner on a main image that is visually recognized through the display unit and based on the display specification, wherein
the environment information includes location information of the user,
the biological information includes brain wave information of the user, and
the determining of the display specification includes determining display time of the sub-image per unit time as the display specification of the sub-image based on the location information of the user and the brain wave information of the user.

14. A non-transitory computer-readable storage medium storing a computer program causing a computer to execute:
detecting biological information of a user;
determining a display specification of a sub-image to be displayed on a display unit based on the biological information of the user;
detecting environment information of a periphery of the display unit; and
causing the display unit to display the sub-image in a superimposed manner on a main image that is visually recognized through the display unit and based on the display specification, wherein
the environment information includes location information of the user,
the biological information includes brain wave information of the user, and
the determining of the display specification includes determining display time of the sub-image per unit time as the display specification of the sub-image based on the location information of the user and the brain wave information of the user.
